(19) United States
(12) Patent Application Publication
(10) Pub. No.: US 2026/0079233 A1
(43) Pub. Date: Mar. 19, 2026

(54) RADAR APPARATUS, SYSTEM, AND METHOD

(71) Applicant: MobilEye Vision Technologies Ltd., Jerusalem (IL)

(72) Inventor: Ophir Shabtay, Tsofit (IL)

(73) Assignee: MobilEye Vision Technologies Ltd., Jerusalem (IL)

(21) Appl. No.: 19/286,793

(22) Filed: Jul. 31, 2025

Related U.S. Application Data
(60) Provisional application No. 63/696,812, filed on Sep. 19, 2024.
(60) Provisional application No. 63/774,001, filed on Mar. 18, 2025.

(51) Int. Cl. G01S 7/02; G01S 13/931

(52) U.S. Cl. CPC G01S 7/0236; G01S 13/931; G01S 2013/9316

(57) ABSTRACT

For example, an apparatus may include a processor, which may be configured to identify a road segment for a vehicle; and to determine a Radar Transmit Configuration (RTC) setting for at least one radar radio of the vehicle based on an RTC allocation corresponding to the road segment. For example, the RTC allocation corresponding to the road segment may be based on a road topology at the road segment. For example, the RTC setting may define a setting of one or more RTC parameters to be implemented for transmission of radar signals by the at least one radar radio at the road segment. For example, the apparatus may include an output to provide RTC setting information based on the RTC setting.

### CROSS-REFERENCE

This application claims the benefit of and priority from U.S. Provisional Patent Application No. 63/774,001, entitled “RADAR APPARATUS, SYSTEM, AND METHOD”, filed Mar. 18, 2025, and from U.S. Provisional Patent Application No. 63/696,812, entitled “RADAR APPARATUS, SYSTEM, AND METHOD”, filed Sep. 19, 2024, the entire disclosures of which are incorporated herein by reference.

### BACKGROUND

Various types of devices and systems, for example, autonomous and/or robotic devices, e.g., autonomous vehicles and robots, may be configured to perceive and navigate through their environment using sensor data of one or more sensor types.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of transmit configurations in a frequency-time space, which may be implemented in accordance with some demonstrative aspects.

FIG. 11 is a schematic illustration of a system, in accordance with some demonstrative aspects.

FIG. 12 is a schematic illustration of an implementation of a radio transmit configuration allocation rule, in accordance with some demonstrative aspects.

FIG. 13 is a schematic illustration of an implementation of a radio transmit configuration allocation rule, in accordance with some demonstrative aspects.

FIG. 14 is a schematic illustration of a Radio Transmit Configuration (RTC) allocation, in accordance with some demonstrative aspects.

FIG. 15 is a schematic illustration of an RTC allocation, in accordance with some demonstrative aspects.

FIG. 16 is a schematic illustration of an RTC allocation, in accordance with some demonstrative aspects.

FIG. 17 is a schematic flow chart illustration of a method of determining an RTC setting for at least one radar radio of a vehicle, in accordance with some demonstrative aspects.

FIG. 18 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances.

Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

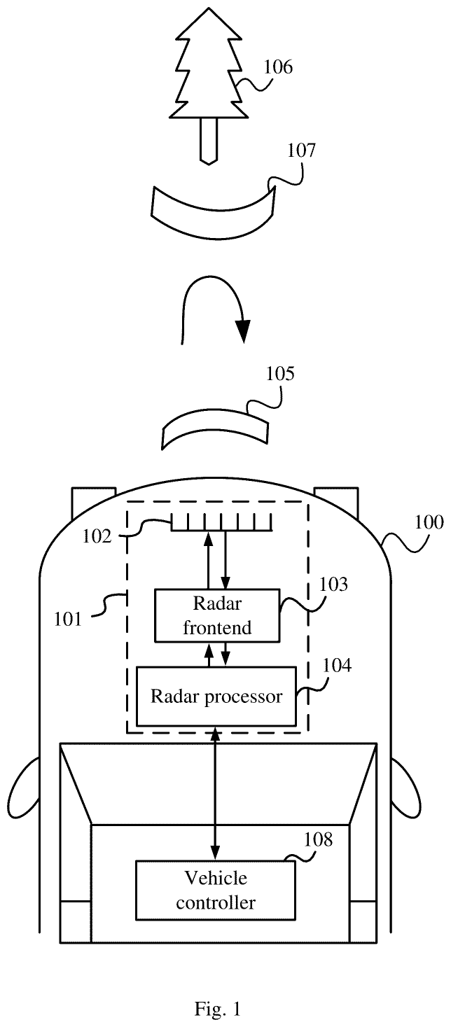

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may be configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identify a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

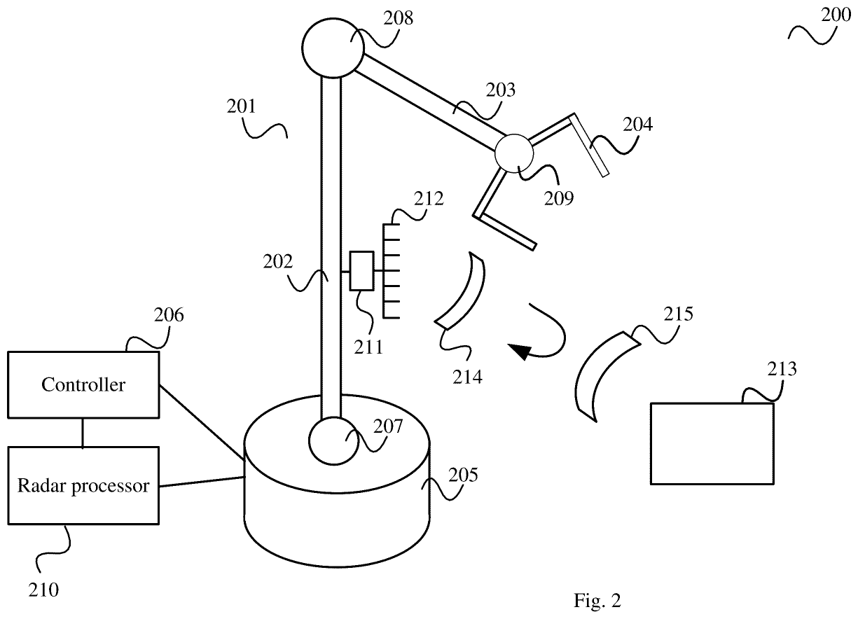

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

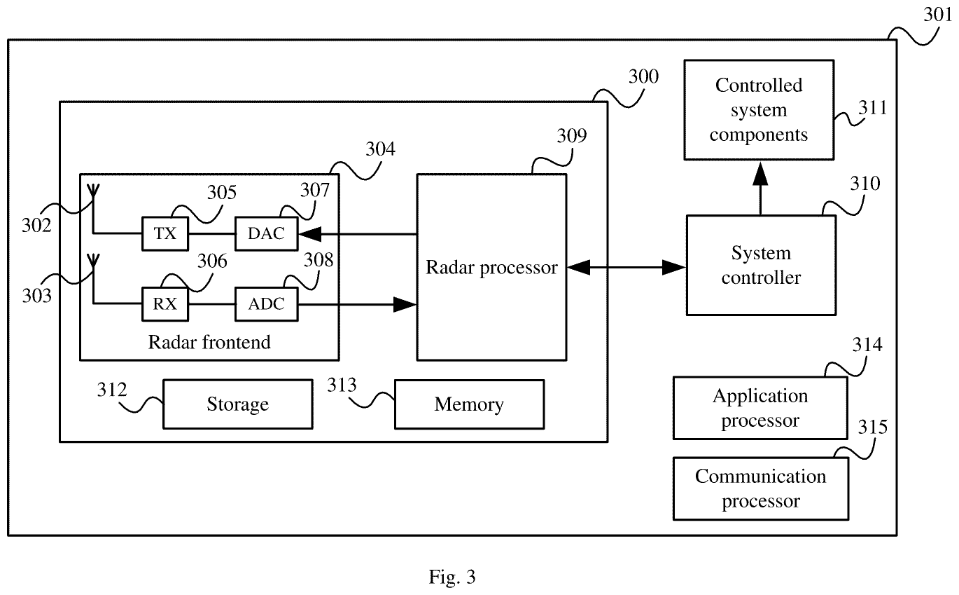

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a Continuous Wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

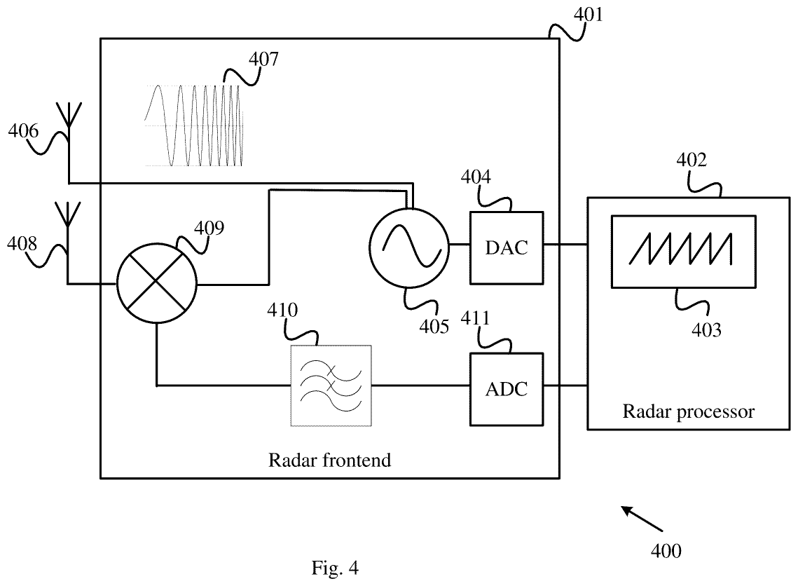

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

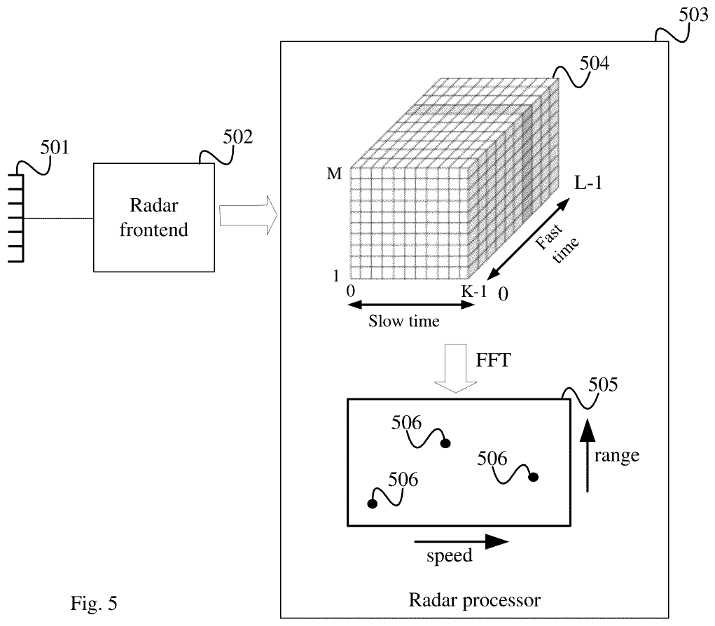

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

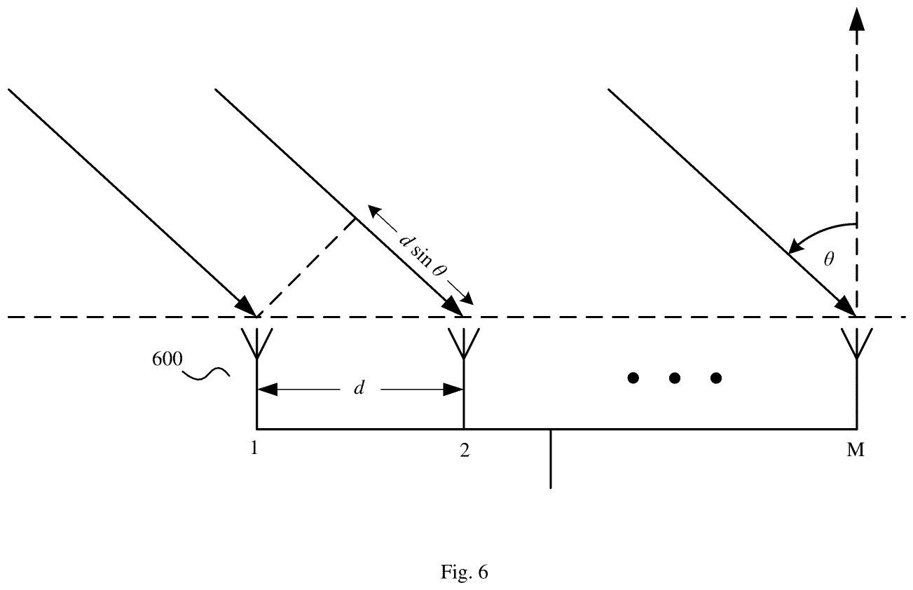

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Ap, between two antennas of the receive antenna array 600 may be determined, e.g., as follows:

$$Δφ = \frac{2 π}{λ} d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

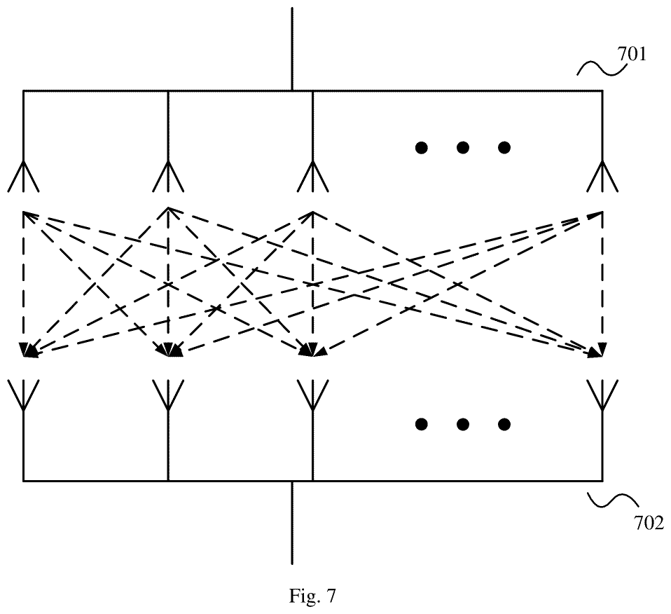

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

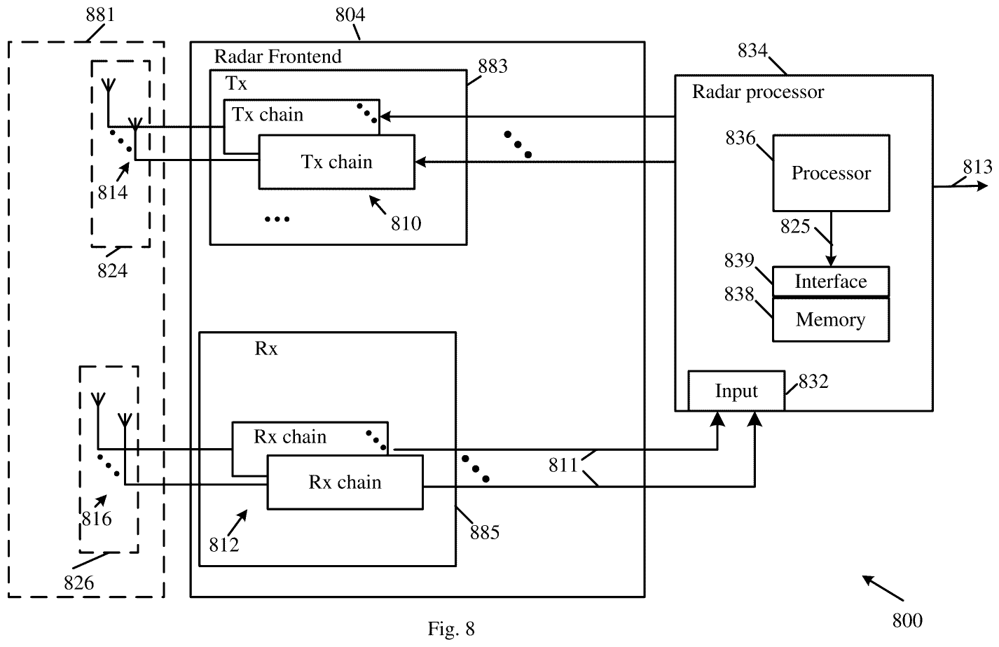

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

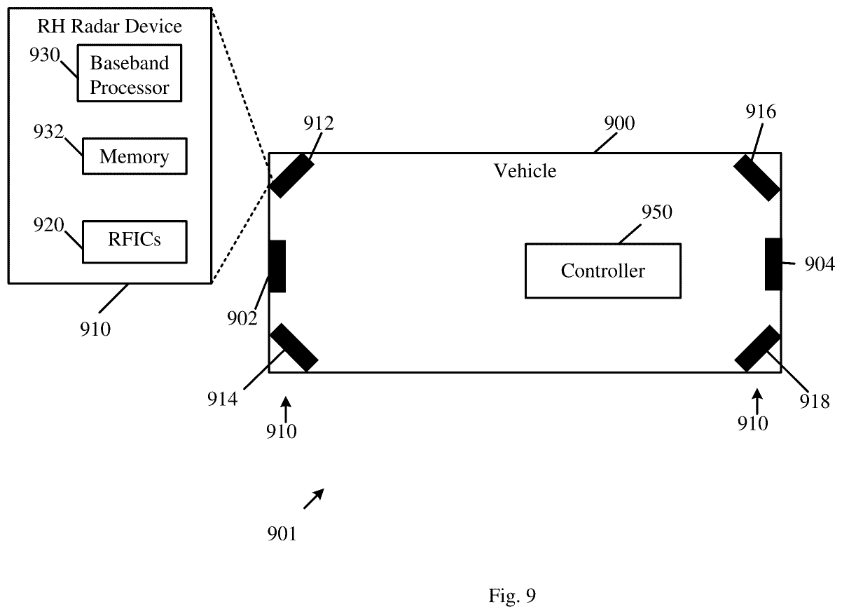

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to provide a technical solution to avoid and/or mitigate interference between the radar device and one or more other radar devices, e.g., as described below.

In some demonstrative aspects, a radar device, e.g., as described above with reference to FIGS. 1-9, may be configured to implement one or more operations and/or functionalities of a Radar Transmit Configuration (RTC) allocation and assignment mechanism, which may be configured to provide a technical solution to support avoidance and/or mitigation of interference between the radar device and one or more other radar devices, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support one or more use cases, deployments, and/or implementations, for example, where there is no central management entity, e.g., a central Medium Access Controller (MAC), which may share RTC settings between radar radios (also referred to as “radar units”) of vehicles on the road, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support one or more use cases, deployments, and/or implementations, where a vehicle, e.g., each vehicle, may operate as a standalone unit that must guarantee reliable radar information for safe operation, e.g., as described below.

For example, radar units may be configured to transmit in radio transmit configurations with overlap of frames, e.g., an overlap in frame time, frequency allocation, polarization, code, frame structure, and/or any other suitable attribute, configuration and/or parameter of radar transmissions, e.g., which may be used to define RTC settings.

For example, in some use cases and/or scenarios, an overlap between transmissions from two or more radar devices, e.g., even a partial overlap, may be harmful, e.g., very harmful, for example, at a radar device, which may process received radar signals (“receiving radar device”). For example, the receiving radar device may be at risk of confusing its own signals with signals received based on transmissions from other vehicles.

For example, this risk of the radar interference may grow over time, for example, as an increasing number of radar radios may be used per vehicle. For example, the risk of the radar interference may grow as radar systems are implemented by an increasing number of new vehicles, and/or as stronger transmit powers may be used. In one example, this risk of the radar interference may be relatively high in crowded areas, e.g., parking lots, or the like.

For example, in some use cases, scenarios, and/or implementations, the radar interference may result in a phenomena of raising a noise floor at the receiving radar device.

For example, this phenomena may occur in case an interfering radar utilizes a different waveform from a waveform utilized by the receiving radar device.

For example, this phenomena of raising the noise floor may result in degraded performance, for example, in terms of reduced sensitivity, e.g., a shorter maximal detection range and/or a reduced number of detections.

For example, the waveform of the interfering radar may have a different modulation, e.g., different chirp parameters, a different pseudo orthogonalization method between transmitters, different codes, a different frame structure, and/or any other suitable attribute, configuration, setting and/or parameter. For example, in many cases, such a difference between the waveform of the interfere and the waveform of the receiving radar device may not necessitate all of the above to appear as noise.

For example, in some use cases, scenarios, and/or implementations, the radar interference may result in a phenomena of creating a ghost target (ghost) or ghosts at the receiving radar device.

For example, these ghosts may appear in case the interfering radar utilizes a similar waveform to the waveform of the receiving radar device. For example, the waveform of the interfering radar may have a similar modulation, e.g., similar chirp parameters, a similar pseudo orthogonalization method between transmitters, similar codes, a similar frame structure, and/or any other suitable attribute, configuration, setting and/or parameter, which may be similar to the waveform utilized by the receiving radar device.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support avoidance and/or mitigation of interference between the radar device and one or more other radar devices, for example, by avoiding and/or mitigating some or all ghost targets, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support avoidance and/or mitigation of interference between radar devices using similar radar waveforms, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support avoidance and/or mitigation of interference between radar devices, which may use identical radar waveforms, e.g., as described below.

In one example, in some cases, radar systems from a same vendor may utilize identical radar waveforms.

For example, in a fleet implementation there may be a relatively high probability that several, or even many, vehicles equipped with radar units from a same vendor may be in vicinity to each other, for example, at a hub, at large sports events, shows, dense urban locations, or the like.

In another example, in some cases, two radars may share the same waveform design, for example, in accordance with a standard and/or other agreed definition with respect to one or more parameters, e.g., chirp parameters, array pseudo orthogonalization, codes, frame structure, or the like. For example, radar devices implemented in accordance with a future standard may be required to utilize similar waveforms and/or frame structures, for example, as may be dictated by such future standard.

In some demonstrative aspects, a radar device, e.g., as described above with reference to FIGS. 1-9, may be configured to implement one or more operations and/or functionalities of an RTC allocation mechanism, which may provide a technical solution to support a more robust and successful future specification and/or standardization.

For example, a problem of a radar transmit configuration allocation may occur, for example, even in case a central management entity, e.g., a radar system MAC entity, may be established, since communicating RTC settings for each and every radar device may be a great challenge, e.g., as such communication may be a critical mission, and today, there is no such a communication infrastructure in place.

For example, one industry trend may be towards a “weak collaboration”, e.g., meaning that an RTC allocation and assignment may be performed without a specific wireless communication.

For example, there exists a technical problem to find a suitable RTC allocation method, and an additional RTC assignment method to communicate these RTC settings to Radar Units (RU), e.g., in a reliable and/or mission critical manner. For example, there may be a need for a technical solution to solve a technical problem of how to allocate the RTCs, and/or a technical problem of how to propagate and/or advertise information regarding the allocation of the RTCs to the radar units.

In some demonstrative aspects, a radar device, e.g., as described above with reference to FIGS. 1-9, may be configured to implement one or more operations and/or functionalities of an RTC allocation mechanism, which may be configured, for example, based on a road topology, a land cover, a shape of a surface, manmade buildings, and/or structures analysis, e.g., as described below.

In some demonstrative aspects, the RTC allocation mechanism may be configured to provide a technical solution to support an improved, e.g., optimized, RTC allocation, for example, with respect to a specific road topology of a specific road segment and/or location, e.g., as described below.

In some demonstrative aspects, the RTC allocation mechanism may be configured to provide a technical solution to support improvement of an RTC allocation, for example, with experience, experiments, and/or measurement. For example, such a learning/improvement procedure may not require a change in HW and/or SW of radar units.

In some demonstrative aspects, the RTC allocation mechanism may be configured to provide a technical solution to consider legacy radar units as given, and to reduce their harm impact.

In some demonstrative aspects, the RTC allocation mechanism may be configured to provide a technical solution to support a global allocation at a low-cost, and/or without human intervention, e.g., at least in an initial allocation, for example, based on simulations, Artificial Intelligence (AI), automation, and/or the like.

In some demonstrative aspects, the RTC allocation mechanism may be configured to provide a technical solution to support ranking of quality. For example, based on the ranking of quality, specific allocations may be changed, and/or priorities may be assigned. For example, specific improvements may be made based on the priorities.

In some demonstrative aspects, the RTC allocation mechanism may be configured to provide a technical solution to support flexibility to changes, e.g., in the road topology, the land cover, the surface shape, the man-made building and structures, demographic changes of traffic statistics, and/or the like.

In some demonstrative aspects, the RTC allocation mechanism may be configured to provide a technical solution to support flexibility to adopt generations of new radar units over time.

In some demonstrative aspects, a radar device, e.g., as described above with reference to FIGS. 1-9, may be configured to implement one or more operations and/or functionalities of an RTC assignment mechanism, which may be based on a map based RTC instruction field, e.g., as described below.

In some demonstrative aspects, the RTC assignment mechanism may be configured to provide a technical solution to support RTC assignment, for example, without a requirement for real time communication, for example, since the RTC assignment may be based on an electronic map, which may be downloaded, e.g., in advance.

In some demonstrative aspects, the RTC assignment mechanism may be configured to provide a technical solution to support a high certainty of the RTC assignment, for example, as the RTC assignment may be encoded in an electronic map.

In some demonstrative aspects, the RTC assignment mechanism may be configured to provide a technical solution to support changes of an RTC assignment, which may be considered, for example, to prevent frequent RTC assignment changes.

In some demonstrative aspects, the RTC assignment mechanism may be configured to provide a technical solution to support utilizing available RTC assignments, for example, in cases when an RTC assignment has failed for some reason.

In some demonstrative aspects, the RTC assignment mechanism may be configured to provide a technical solution to support flexibility to adoption to changes, e.g., as described above.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support RTC allocation in a mmWave band between 76 GHz and 81 GHz, e.g., as described below. In other aspects, the RTC allocation may be configured for any other additional or alternative suitable RF band.

For example, automotive radar units may be configured to transmit in a mmWave band between 76 GHz and 81 GHz. Currently, most of Original Equipment Manufacturers (OEMs) may configure radar units to transmit only in a frequency band between 76 GHz and 77 GHz, since this is the only frequency band that is more or less uniform across the globe, e.g., in terms of regulatory requirements.

Currently, there is a need to address a technical problem where there is no known MAC method for radar units installed in vehicles on the road, hence, the radar units may transmit at will and may cause interference to each other.

For example, an interference between an Interferer RU (IRU) and a Victim RU (VRU) may have two “faces” with different power, e.g., as descried below.

For example, a direct exposure interference case may occur, for example, when the VRU and the IRU may have a line-of-sight topology, where a Field of View (FoV) of the VRU and a FoV of the IRU may overlap. For example, in such case a radar equation model may suggest a power law, which may be proportional to a distance (R) between the VRU and the IRU, e.g., proportional to 1/R\hat{ }2.

For example, an indirect exposure interference case may occur, for example, when the VRU receives interference radar energy from the IRU, for example, through multi path and/or reflection of radar signals from the IRU via one or more objects. For example, in such case, the power law may be proportional to

$$\frac{1}{{R}_{1}^{2}} \cdot \frac{1}{{R}_{2}^{2}} ,$$

wherein R₁ denotes the distance between the IRU and an object, and R₂ denotes the distance between the VRU and the same object. For example, the object should be in both the FOV of the VRU and the FOV of the IRU.

In one example, the indirect exposure interference may usually be of lower power, but may be undesired and may cause miss-detections and/or ghosts.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support radar sensing, which may be reliable and robust, for example, with reduced, e.g., minimal, miss-detections and ghosts being left for the VRU to handle.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support radar sensing, which may be reliable and robust, e.g., with minimal miss-detections and ghosts, for example, for the direct exposure interference case.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support radar sensing, which may be reliable and robust, e.g., with minimal miss-detections and ghosts, for example, for the indirect exposure interference case.

In some demonstrative aspects, an RTC allocation may be configured to define settings of physical characteristics of a transmitted signal, which may enable a cancelation, or at least a large attenuation, of transmitted signals that are in a different RTC setting, for example, utilizing relatively low compute resources. For example, the relative low compute resources may mean that a VRU may not be required to learn and subtract, attenuate, and/or orthogonalize, interference signals from IRUs.

In some demonstrative aspects, the RTC allocation may include a setting of one or more Radio Resources (RRs), e.g., as described below.

For example, Radio Resources (RR) may be an established concept in wireless systems, where RR may be defined in a standard, and may be regulated by a MAC layer of a wireless system.

For example, some types of RTC settings may include non-overlapping frequency ranges, non-overlapping time slots, Diagonal Time-Frequency allocations, different waveforms that are far from each other in a waveform space, code based separation, e.g., similar to CDMA, orthogonal polarization, differences in the frame structure, e.g., that enable attenuation of interfering signals, and/or any other additional or alternative settings.

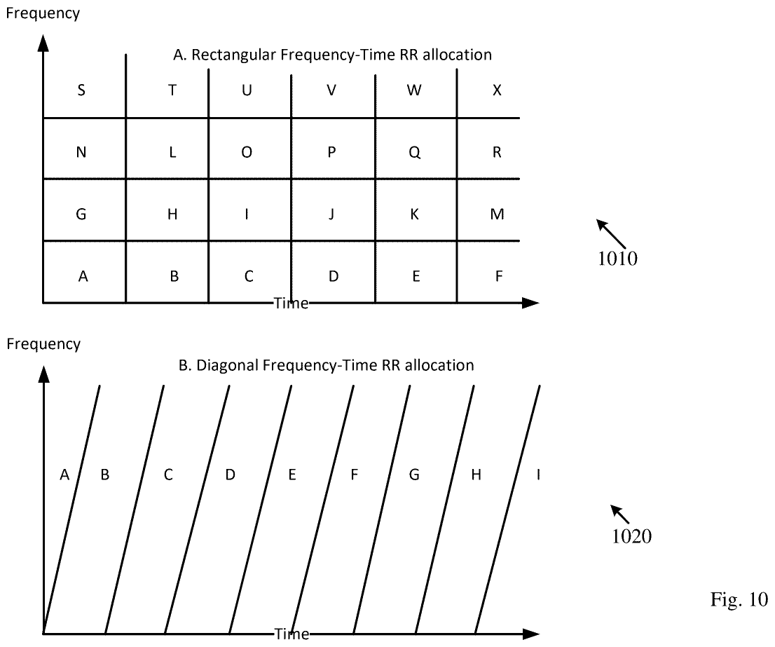

Reference is made to FIG. 10, which schematically illustrates radio transmit configurations in a frequency-time space, which may be implemented in accordance with some demonstrative aspects.

For example, a rectangular RTC allocation scheme 1010 may include a plurality of different frequency-time RTCs.

For example, a diagonal frequency-time RTC allocation scheme 1020 may be used.

For example, each RTC configuration of diagonal RTC allocation scheme 1020 may utilize a same chirp at a different time. For example, diagonal RTC allocation scheme 1020 may be more applicable to radar devices, for example, utilizing a chirp waveform or a Linear Frequency Modulated (LFM) waveform.

It is noted that the RTC allocation scheme 1010 and the diagonal RTC allocation scheme 1020 are only two examples of RTC allocations. In other aspects, any other suitable RTC allocations may be implemented.

In some demonstrative aspects, there may be one or more technical issues when implementing a random-hopping method, for example, to assign an RTC configuration to a plurality of radar devices.

In one example, the random-hopping method may not be practical, as it may require a number of required RTC configurations, which may be higher than a number of available RTC configurations.

For example, there may be a relatively large number of radar units, which may be at close proximity to each other at a given time. In one example, e.g., in a highway scenario, there may be an average of 525 radar units. In another example, e.g., in an intersection scenario, there may be an average of 170 radar units. For example, there may be an active link percentage of about 60% in both cases, for example, even if only direct interference is considered, e.g., without taking into account an in-direct interference.

For example, there may be a limited amount of available “strong radar transmit” configurations. For example, there may be about 80 different available “strong radar transmit” configurations, for example, utilizing 4 central frequencies, e.g., a 250 MHz BW in the 76-77 GHz global band, 5 time slots, e.g., for a sync system with 20 Frame Per Second (FPS), and four far away waveforms, e.g., 4*5*4=80.

For example, this limited number of different strong radar transmit configurations may not be sufficient for supporting the RTC allocation in the highway scenario according to the random-hopping method.

For example, as there may be more active links than radio resources, e.g., only 80 out of 0.6*525=315 radar units may be able to utilize different RTCs. Accordingly, a repetition factor of about 4 may be utilized for the RTC allocation according to the random-hopping method. Therefore, the random-hopping method may have only partial effectiveness.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support allocation and assignment of RTCs in a practical manner, for example, which may be sufficient for different scenarios, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support allocation and assignment of RTCs in a practical manner, for example, based on a road segment, e.g., as described below.

In some demonstrative aspects, a radar device, e.g., as described above with reference to FIGS. 1-9, may be configured to implement one or more operations and/or functionalities of an RTC allocation and assignment mechanism, which may be configured to provide a technical solution to support allocation and assignment of RTCs in a practical manner, for example, based on a road topology of the road segment, e.g., as described below.

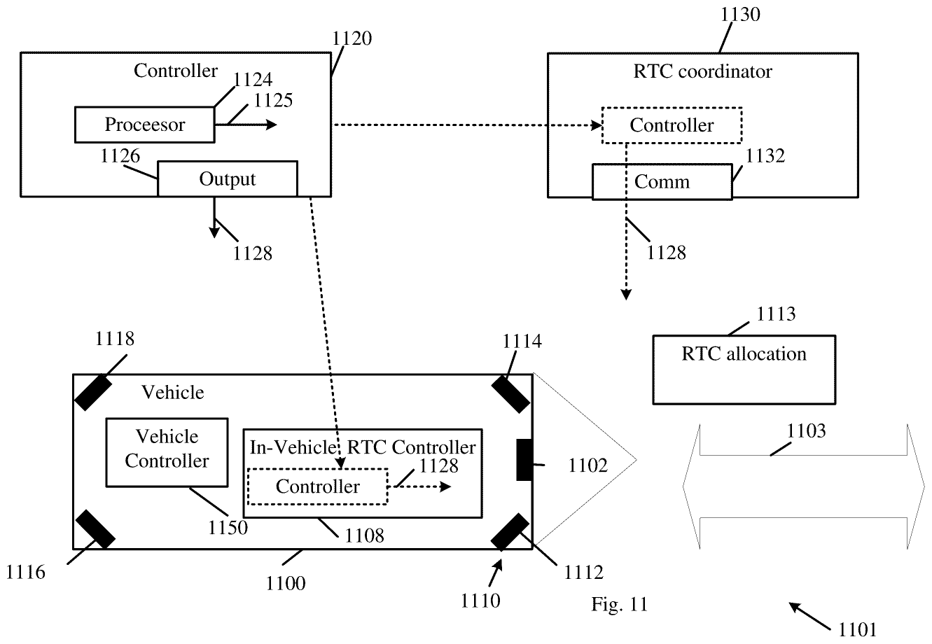

Reference is made to FIG. 11, which schematically illustrates a system 1101 in accordance with some demonstrative aspects.

In some demonstrative aspects, one or more elements of the system 1101 may be implemented by a radar device, e.g., radar device 800 (FIG. 8) and/or radar device 910 (FIG. 9), and/or a radar system, e.g., radar system 901 (FIG. 9).

In some demonstrative aspects, one or more elements of the system 1101 may be implemented by a coordinator, e.g., as described below.

In some demonstrative aspects, system 1101 may include an RTC controller 1120, which may be configured to determine an RTC setting 1125 for at least one radar radio 1110 of a vehicle 1100, e.g., as described below.

In some demonstrative aspects, vehicle 1100 may include a plurality of radar radios 1110, which may be located, for example, at a plurality of radar installment spatial poses relative to vehicle 1100, for example, to provide radar sensing at a large field of view around vehicle 1100.

In some demonstrative aspects, as shown in FIG. 11, the plurality of radar radios 1110 may include, for example, five radar radios 1110.

In other aspects, the plurality of radar radios 1110 may include any other number of radar radios 1110, e.g., less than five radar radios or more than five radar radios.

In some demonstrative aspects, as shown in FIG. 11, vehicle 1100 may include a first radar radio 1102, e.g., a front radar radio, at a front-side of vehicle 1100.

In some demonstrative aspects, as shown in FIG. 11, vehicle 1100 may include one or more radar radios at one or more respective corners of vehicle 1100.

For example, vehicle 1100 may include a first corner radar radio 1112, e.g., at a front-right corner of vehicle 1100, a second corner radar radio 1114, e.g., at a front-left corner of vehicle 1100, a third corner radar radio 1116, e.g., at a back-right corner of vehicle 1100, and/or a fourth corner radar radio 1118 at a back-left corner of vehicle 1100.

In some demonstrative aspects, vehicle 1100 may include one, some, or all, of the plurality of Radar radios 1110 shown in FIG. 11.

In other aspects, the radar radios 1110 may be arranged according to any other suitable arrangement.

In some demonstrative aspects, RTC controller 1120 may include a processor 1124, which may be configured to identify a road segment 1103 for vehicle 1100, e.g., as described below.

In some demonstrative aspects, processor 1124 may include, or may be implemented, partially or entirely, by circuitry and/or logic, e.g., one or more processors including circuitry and/or logic, memory circuitry and/or logic. Additionally or alternatively, one or more functionalities of processor 1124 may be implemented by logic, which may be executed by a machine and/or one or more processors, e.g., as described below.

In one example, processor 1124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, processor 1124 may be configured to determine the RTC setting 1125 for the at least one radar radio 1110 of the vehicle 1100, for example, based on an RTC allocation 1113 corresponding to the road segment 1103, e.g., as described below.

In some demonstrative aspects, the RTC allocation 1113 corresponding to the road segment 1103 may be based, for example, on a road topology at the road segment 1103, e.g., as described below.

In some demonstrative aspects, the RTC setting 1125 may define a setting of one or more RTC parameters to be implemented for transmission of radar signals by the at least one radar radio 1110 at the road segment 1103, e.g., as described below.

In some demonstrative aspects, RTC controller 1120 may include an output 1126, which may be configured, for example, to provide RTC setting information 1128, for example, based on the RTC setting 1125, e.g., as described below.

In some demonstrative aspects, output 1126 may include any suitable output interface, output unit, output module, output component, output circuitry, memory interface, memory access unit, memory writer, digital memory unit, bus interface, processor interface, or the like, which may be capable of outputting the RTC setting information 1128 to a memory, a processor, and/or any other suitable component to handle the RTC setting information 1128.

In some demonstrative aspects, the one or more RTC parameters may include a frequency range, e.g., as described below.

In some demonstrative aspects, the one or more RTC parameters may include a time slot, e.g., as described below.

In some demonstrative aspects, the one or more RTC parameters may include a waveform, e.g., as described below.

In some demonstrative aspects, the one or more RTC parameters may include a polarization, e.g., as described below.

In some demonstrative aspects, the one or more RTC parameters may include a coding, e.g., as described below.

In some demonstrative aspects, the one or more RTC parameters may include a frame structure, e.g., as described below.

In other aspects, the one or more RTC parameters may include any other additional and/or alternative suitable parameter, which may be utilized to define the RTC setting 1125.

In some demonstrative aspects, processor 1124 may be configured to determine the RTC setting 1125 to define the setting of the one or more RTC parameters, for example, based on a spatial pose, e.g., a radar installation spatial pose, of the at least one radar radio of the vehicle 1100, e.g., as described below.

In some demonstrative aspects, the spatial pose of the at least one radar radio 1110 may include a location and/or a position, e.g., an installment location and/or position, of the at least one radar radio 1110 at the vehicle 1100.

In some demonstrative aspects, the spatial pose of the at least one radar radio 1110 may include an orientation and/or a direction, e.g., an installment orientation and/or a direction, of the at least one radar radio 1110. For example, the spatial pose of the at least one radar radio 1110 may include an orientation and/or a direction of a boresight of the at least one radar radio 1110.

In some demonstrative aspects, processor 1124 may be configured to determine the RTC setting 1125 to define a first setting of the one or more RTC parameters for a first radar radio at a first spatial pose, e.g., as described below.

In some demonstrative aspects, processor 1124 may be configured to determine the RTC setting 1125 to define a second setting of the one or more RTC parameters for a second radar radio at a second spatial pose, e.g., as described below.

In some demonstrative aspects, the second setting of the one or more RTC parameters may be different from the first setting of the one or more RTC parameters, e.g., as described below.

In one example, processor 1124 may be configured to determine the RTC setting 1125 to define a first setting of the one or more RTC parameters for the radar radio 1102, and to define a second setting of the one or more RTC parameters for the radar radio 1112, which may be different from the first setting of the one or more RTC parameters.

In another example, processor 1124 may be configured to determine the RTC setting 1125 to define a first setting of the one or more RTC parameters for the radar radio 1112, and to define a second setting of the one or more RTC parameters for the radar radio 1114, which may be different from the first setting of the one or more RTC parameters.

In another example, processor 1124 may be configured to determine the RTC setting 1125 to define a first setting of the one or more RTC parameters for the radar radio 1112, and to define a second setting of the one or more RTC parameters for the radar radio 1116, which may be different from the first setting of the one or more RTC parameters.

In some demonstrative aspects, the RTC allocation 1113 may be based, for example, on a lane configuration of one or more lanes at the road segment 1103, e.g., as described below.

In some demonstrative aspects, the lane configuration may include a count of the one or more lanes, e.g., as described below.

In some demonstrative aspects, the lane configuration may include a driving-direction of the one or more lanes, e.g., as described below.

In other aspects, the lane configuration may include any other additional and/or alternative parameters and/or information of the lanes.

In some demonstrative aspects, the RTC allocation 1113 may be based, for example, on one or more road traces at the road segment 1103, e.g., as described below.

In some demonstrative aspects, the RTC allocation 1113 may be based, for example, on a junction topology at the road segment 1103, e.g., as described below.

In some demonstrative aspects, the RTC allocation 1113 may be based, for example, on an interchange topology at the road segment 1103, e.g., as described below.

In some demonstrative aspects, the RTC allocation 1113 may be based, for example, on a roundabout topology at the road segment 1103, e.g., as described below.

In some demonstrative aspects, the RTC allocation 1113 may be based, for example, on a ramp topology at the at the road segment 1103, e.g., as described below.

In some demonstrative aspects, the RTC allocation 1113 may be based, for example, on a land cover at the road segment 1103, e.g., as described below.

In some demonstrative aspects, the RTC allocation 1113 may be based, for example, on a parking area topology at the road segment 1103.

In one example, the RTC allocation 1113 may be configured, for example, with respect to a parking area topology, which may include markings of parking spots/spaces and/or driving paths.

In another example, the RTC allocation 1113 may be configured, for example, with respect to a parking area topology, which may not include clear markings of parking spots/spaces and/or driving paths.

In other aspects, the RTC allocation 1113 may be based on any other additional and/or alternative type of topology and/or road attribute at the road segment 1103.

In some demonstrative aspects, the RTC allocation 1113 corresponding to the road segment 1103 may be configured, for example, based on a direct-interference avoidance criterion, e.g., as described below.

In some demonstrative aspects, the direct-interference avoidance criterion may be configured to avoid direct interference caused by radar signals transmitted from a first radar radio of a first vehicle 1100 in the road segment 1103 and received directly by a second radar radio of a second vehicle 1100 in the road segment 1103, e.g., as described below.

In some demonstrative aspects, the RTC allocation 1113 corresponding to the road segment 1103 may be configured, for example, based on an indirect-interference avoidance criterion, e.g., as described below.

In some demonstrative aspects, the indirect-interference avoidance criterion may be configured to avoid indirect interference caused by radar signals transmitted from a first radar radio of a first vehicle 1100 in the road segment 1103 and received, via reflection from one or more objects, by a second radar radio of a second vehicle 1100 in the road segment 1103, e.g., as described below.

In some demonstrative aspects, the RTC allocation corresponding to the road segment 1103 may be configured, for example, to allow or prohibit assignment of a same RTC setting to the first radar radio and the second radar radio according to a Line of Sight (LoS) rule, e.g., as described below.

In some demonstrative aspects, the LoS rule may be configured, for example, to identify whether or not a LoS between the first radar radio and the second radar radio according to the road topology passes through both a first Field of View (FoV) of the first radar radio and a second FoV of the second radar radio, e.g., as described below.

In some demonstrative aspects, the RTC allocation corresponding to the road segment may be configured, for example, to allow or prohibit assignment of a same RTC setting to the first radar radio and the second radar radio according to a boresight rule, e.g., as described below.

In some demonstrative aspects, the boresight rule may be configured, for example, to identify whether or not a first boresight of the first radar radio according to the road topology is within a predefined margin from a second boresight of the second radar radio according to the road topology at the road segment 1103.

In some demonstrative aspects, the predefined margin implemented by the boresight rule may be based, for example, on the road topology at the road segment 1103, e.g., as described below.

In some demonstrative aspects, the direct-interference avoidance criterion may be configured, for example, to selectively allow or prohibit assignment of a same RTC setting to the first radar radio and the second radar radio, for example, based on the LoS rule, e.g., as described below.

In some demonstrative aspects, the direct-interference avoidance criterion may be configured, for example, to allow assignment of a same RTC setting to the first radar radio and the second radar radio, for example, in case the LoS rule is satisfied, for example, if the LoS between the first radar radio and the second radar radio according to the road topology at the road segment 1103 does not pass through both the first FoV of the first radar radio and the second FoV of the second radar radio, e.g., as described below.

In some demonstrative aspects, the direct-interference avoidance criterion may be configured, for example, to prohibit assignment of a same RTC setting to the first radar radio and the second radar radio, for example, in case the LoS rule is not satisfied, for example, if the LoS between the first radar radio and the second radar radio according to the road topology at the road segment 1103 does pass through both the first FoV of the first radar radio and the second FoV of the second radar radio, e.g., as described below.

In some demonstrative aspects, the direct-interference avoidance criterion may be configured, for example, to allow assignment of a same RTC setting to the first radar radio and the second radar radio, for example, in case the LoS rule is satisfied, for example, in case the LoS between the first radar radio and the second radar is blocked according to the road topology at the road segment 1103, for example, if the LoS is blocked by a land-cover, e.g., a building, an interchange, or the like, e.g., as described below.

In some demonstrative aspects, the RTC allocation 1113 corresponding to the road segment 1103 may be configured, for example, to prohibit allocation of a same RTC setting to a first vehicle 1100 in a first lane segment of a first lane having a first driving direction, and to a second vehicle 1100 in a second lane segment of a second lane having a second driving direction, for example, if a LoS between the first lane segment and the second lane segment is clear according to the road topology corresponding to the road segment 1103, e.g., as described below.

In some demonstrative aspects, the RTC allocation 1113 corresponding to the road segment 1103 may be configured, for example, to allow allocation of the same RTC setting to the first vehicle 1100 and the second vehicle 1100, for example, if the LoS between the first lane segment and the second lane segment is blocked according to the road topology corresponding to the road segment 1103, e.g., as described below.

In some demonstrative aspects, the direct-interference avoidance criterion may be configured, for example, to selectively allow or prohibit assignment of a same RTC setting to the first radar radio and the second radar radio, for example, based on a direct-interference avoidance boresight rule, e.g., as described below.

In some demonstrative aspects, the direct-interference avoidance criterion may be configured, for example, to allow assignment of a same RTC setting to the first radar radio and the second radar radio according to a direct-interference avoidance boresight rule, which may require that a first boresight of the first radar radio according to the road topology is within a predefined margin from a second boresight of the second radar radio according to the road topology at the road segment 1103, e.g., as described below.

In some demonstrative aspects, the indirect-interference avoidance criterion may be configured, for example, to selectively allow or prohibit assignment of a same RTC setting to the first radar radio and the second radar radio, for example, based on an indirect-interference avoidance boresight rule, which may require that the first boresight of the first radar radio according to the road topology is not within a predefined margin from a second boresight of the second radar radio according to the road topology at the road segment 1103, e.g., as described below.

In some demonstrative aspects, the indirect-interference avoidance criterion may be configured, for example, to prohibit assignment of a same RTC setting to the first radar radio and the second radar radio, for example, in case the first boresight of the first radar radio according to the road topology is within a predefined margin from the second boresight of the second radar radio according to the road topology, e.g., as described below.

In some demonstrative aspects, the indirect-interference avoidance criterion may be configured, for example, to allow assignment of a same RTC setting to the first radar radio and the second radar radio, for example, in case the first boresight of the first radar radio according to the road topology is not within the predefined margin from the second boresight of the second radar radio according to the road topology, e.g., as described below.

In some demonstrative aspects, the predefined margin implemented by the boresight rule, e.g., for the direct-interference avoidance criterion an/or the indirect-interference avoidance criterion, may be based, for example, on the road topology at the road segment 1103, e.g., as described below.

In some demonstrative aspects, the predefined margin implemented by the boresight rule may include a first predefined margin, which may be implemented, for example, when the road topology at the road segment 1103 includes a driving route, which is generally straight or which has a relatively small curvature, e.g., a curvature below a predefined curvature threshold.

For example, the first predefined margin may be relatively small, e.g., a margin of about +/−5 degrees (deg), +/−10 deg, or any other suitable value.

In some demonstrative aspects, the predefined margin implemented by the boresight rule may include a second predefined margin, which may be implemented, for example, when the road topology at the road segment 1103 includes a driving route, which has a relatively large curvature, e.g., a curvature above the predefined curvature threshold.

For example, the second predefined margin may be relatively large, e.g., a margin of about +/−30 degrees (deg), +/−45 deg, or any other suitable value.

In some demonstrative aspects, the RTC allocation 1113 corresponding to the road segment 1103 may be configured, for example, to assign a plurality of sets of RTC settings to a plurality of lanes in the road segment 1103, e.g., as described below.

In some demonstrative aspects, the plurality of sets of RTC settings may include a first set of RTC settings for vehicles in a first lane, e.g., as described below.

In some demonstrative aspects, the plurality of sets of RTC settings may include a second set of RTC settings for vehicles in a second lane, e.g., as described below.

In some demonstrative aspects, the first set of RTC settings may be different from the second set of RTC settings, e.g., as described below.

In some demonstrative aspects, the first set of RTC settings may include a plurality of first RTC settings corresponding to a plurality of radar installment spatial poses for the vehicles in the first lane, e.g., as described below.

In some demonstrative aspects, the second set of RTC settings may include a plurality of second RTC settings corresponding to the plurality of radar installment spatial poses for the vehicles in the second lane, e.g., as described below.

In some demonstrative aspects, processor 1124 may be configured to select a particular set of RTC settings from the plurality of sets of RTC settings, for example, based on a particular lane for the vehicle 1100, e.g., as described below.

In some demonstrative aspects, processor 1124 may be configured to determine the RTC setting 1125 for the at least one radar radio 1110 of the vehicle 1100 to include at least one particular RTC setting in the particular set of RTC settings, e.g., as described below.

In some demonstrative aspects, the RTC setting 1125 may include an along-lane setting, e.g., as described below.

In some demonstrative aspects, the along-lane setting may be configured to define a setting of at least one RTC parameter of the one or more RTC parameters, for example, based on a location of the vehicle 1100 along a lane, e.g., as described below.

In some demonstrative aspects, the RTC allocation 1113 corresponding to the road segment 1103 may be configured, for example, to define a plurality of predefined along-lane settings for the at least one RTC parameter, e.g., as described below.

In some demonstrative aspects, processor 1124 may be configured to select a particular along-lane setting from the plurality of predefined along-lane settings, e.g., as described below.

In some demonstrative aspects, processor 1124 may be configured to randomly select the particular along-lane setting from the plurality of predefined along-lane settings, e.g., as described below.

In other aspects, processor 1124 may be configured to select the particular along-lane setting from the plurality of predefined along-lane settings according to any other suitable section mechanism and/or criterion, e.g., as described below.

In some demonstrative aspects, processor 1124 may be configured to configure the RTC setting 1125 to include the particular along-lane setting for the at least one RTC parameter, e.g., as described below.

In some demonstrative aspects, processor 1124 may be configured to adjust the setting of the at least one RTC parameter, for example, based on the location of the vehicle 1100 along the particular lane, e.g., as described below.

In some demonstrative aspects, the RTC allocation 1113 corresponding to the road segment 1103 may be configured, for example, to reuse the plurality of predefined along-lane settings, for example, with respect to a plurality of lane portions along the lane, e.g., as described below.

For example, the RTC allocation 1113 corresponding to the road segment 1103 may be configured, for example, to reuse the plurality of predefined along-lane settings, for example, by repeatedly using the same plurality of predefined along-lane settings for two or more, e.g., for each, of the plurality of lane portions along the lane.

In some demonstrative aspects, the RTC allocation 1113 corresponding to the road segment 1103 may be configured, for example, such that a length of a lane portion of the plurality of lane portions is based on a count of predefined along-lane settings in the plurality of predefined along-lane settings, e.g., as described below.

In some demonstrative aspects, processor 1124 may be configured to identify RTC allocation information in map information of a map segment corresponding to the road segment 1103, e.g., as described below.

In some demonstrative aspects, the RTC allocation 1113 may be based on a road topology at the road segment 1103, which may be based on and/or related to mapping information of a map, e.g., a map segment, of the road segment 1103.

In other aspects, the RTC allocation 1113 may be based on a road topology at the road segment 1103, which may be based on and/or related to any other information, e.g., independent of and/or separate from, the mapping information. In one example, the RTC allocation 1113 may be based on a road topology at the road segment 1103, which may be defined, for example, by lane, by junction, a number of lanes, and/or any other additional or alternative road topology attribute corresponding to the road segment 1103.

In some demonstrative aspects, the map information may be retrieved by processor 1124 and/or by a vehicle controller 1150 of vehicle 1100.

In one example, vehicle controller 1150 may be configured to download, e.g., from a mapping service and/or from an RTC coordinator 1130, one or more map segments, for example, High Definition (HD) map segments. For example, the map segments may be retrieved based on a current location of vehicle 1100, one or more available map segments in a local memory of vehicle controller 1150, a navigation plan of the vehicle 1100, one or more estimated map segments corresponding to the navigation plan of the vehicle 1100, and/or any other suitable criteria.

In one example, the processor 1124 may be configured to retrieve the RTC allocation information from the map information of a map segment.

In another example, vehicle controller 1150 may be configured to retrieve the RTC allocation information from the map information of a map segment, and to provide the RTC allocation information to the processor 1124.

In some demonstrative aspects, the RTC allocation information may be communicated to, and/or retrieved by, processor 1124 based on map information corresponding to a map segment, e.g., as described above.

In other aspects, the RTC allocation information may be communicated to, and/or retrieved by, processor 1124, for example, from the RTC coordinator 1130, for example, based on a location of the vehicle 1100, e.g., as described below.

In some demonstrative aspects, the RTC allocation information may define the RTC allocation 1113 corresponding to the road segment 1103, e.g., as described below.

In some demonstrative aspects, the RTC allocation information may include a plurality of RTC entries corresponding to a plurality of scenarios, e.g., as described below.

In some demonstrative aspects, a scenario may include, may be based on, and/or may relate to a particular scheme, setting, arrangement, and/or configuration, for example, with respect to a road topology, a driving state, a radar radio, and/or any suitable combination thereof.

In one example, a scenario may include, may be based on, and/or may relate to a particular road topology scheme, for example, a highway scenario, an intersection scenario, a roundabout scenario, and/or the like.

In another example, a scenario may include, may be based on, and/or may relate to a particular driving state, driving location, driving lane, driving direction, driving speed, and/or the like.

In another example, a scenario may include, may be based on, and/or may relate to a particular spatial pose of a radar unit, for example, a front unit, a rear unit, a corner unit, a right-corner unit, a left-corner unit, a front-right-corner unit, a front-left-corner unit, a rear-right-corner unit, a rear-left-corner unit, and/or the like.

In one example, a first scenario may be defined to include a combination of a highway, a first lane number, and a first radar unit spatial pose, e.g., a highway, lane 3, and front-right-corner unit.

In another example, a second scenario may be defined to include a combination of a highway, a second lane number, and a second radar unit spatial pose, e.g., a highway, lane 2, and front-right-corner unit.

In another example, a third scenario may be defined to include a combination of a highway, a third lane number, and a third radar unit spatial pose, e.g., a highway, lane 1, and front-left-corner unit.

In one example, a fourth scenario may be defined to include a combination of an intersection, a forth lane number, and a fourth radar unit spatial pose, e.g., an intersection, lane 1, and front unit.

In other aspects, the scenario may include, may be based on, and/or may relate to any other additional or alternative setting, scheme, configuration, attribute, and/or parameter.

In some demonstrative aspects, an RTC entry corresponding to a scenario may include scenario-based RTC information to define a scenario-based setting of the one or more RTC parameters for the scenario, e.g., as described below.

In some demonstrative aspects, the plurality of RTC entries may include a first RTC entry corresponding to a first scenario and a second RTC entry corresponding to a second scenario, e.g., as described below.

In some demonstrative aspects, the first RTC entry may include first scenario-based RTC information to define a first setting of the one or more RTC parameters for the first scenario, e.g., as described below.

In some demonstrative aspects, the second RTC entry may include second scenario-based RTC information to define a second setting, e.g., different from the first setting, of the one or more RTC parameters for the second scenario, e.g., as described below.

In some demonstrative aspects, the RTC entry may include scenario information to define the scenario, for example, based on a lane identifier, e.g., as described below.

In some demonstrative aspects, the RTC entry may include scenario information to define the scenario, for example, based on a radar installment spatial pose, e.g., as described below.

In some demonstrative aspects, the scenario-based RTC information may include along-lane setting information to define a setting of at least one RTC parameter of the one or more RTC parameters for the scenario, for example, based on the location of the vehicle 1100 along the lane, e.g., as described below.

In other aspects, the RTC entry may include any other suitable additional or alternative information.

In some demonstrative aspects, RTC controller 1120 may be implemented, for example, as part of vehicle 1100, e.g., as described below.

In some demonstrative aspects, vehicle 1100 may include an in-vehicle RTC controller 1108, which may be configured for implementation in the vehicle 1100.

In some demonstrative aspects, in-vehicle RTC controller 1108 may include RTC controller 1120, e.g., as described below.

In some demonstrative aspects, in-vehicle RTC controller 1108 may include the processor 1124, e.g., as described below.

In some demonstrative aspects, in-vehicle RTC controller 1108 may include the output 1126, for example, to provide the RTC setting information 1128 to the at least one radar radio 1110, e.g., as described below.

In some demonstrative aspects, processor 1124 may be configured to determine the RTC allocation 1113 corresponding to the road segment 1103, for example, based on RTC allocation information received by the vehicle 1100, e.g., as described below.

In some demonstrative aspects, the in-vehicle RTC controller 1108 may be configured to identify a location of vehicle 1100, and a driving route of vehicle 1100, for example, based on suitable input information, for example, a navigation system input, turning indications, and/or the like.

In some demonstrative aspects, the in-vehicle RTC controller 1108 may be configured to download a relevant map, a map tile, a map segment, or a set of rules, for example, with a geographic validity, e.g., between junctions, roundabout, intersections, and/or the like.

In some demonstrative aspects, the in-vehicle RTC controller 1108 may be configured to identify RTC allocation information in map information of a map segment corresponding to the road segment 1103 to be travelled by the vehicle 1100, e.g., as described below.

In some demonstrative aspects, the in-vehicle RTC controller 1108 may be configured to process the RTC allocation information to identify the RTC allocation 1113 corresponding to the road segment 1103.

In some demonstrative aspects, the in-vehicle RTC controller 1108 may be configured to identify a lane in road segment 1103 to be travelled by the vehicle 1100.

In some demonstrative aspects, the in-vehicle RTC controller 1108 may be configured to identify time boundaries corresponding to road segment 1103.

In some demonstrative aspects, the in-vehicle RTC controller 1108 may be configured to instruct the one or more radar radios 1110, for example, for their RTC settings, for example, based on the RTC allocation 1113 corresponding to the road segment 1103.

In some demonstrative aspects, the in-vehicle RTC controller 1108 may be configured to instruct the one or more radar radios 1110, for example, to perform a measurement to dynamically determine a waveform subclass, e.g., as described below.

In some demonstrative aspects, the in-vehicle RTC controller 1108 may be configured to prepare a following set of RTC settings to radar radios 1110 for a next road segment 1103, for example, based on a navigation route of vehicle 1100 and/or navigation instructions for vehicle 1100.

In one example, the next road segment 1103 may be determined based on a turn off of the main road.

In another example, the next road segment 1103 may be determined based on rule defined geo boundaries.

In some demonstrative aspects, RTC controller 1120 may be implemented, for example, as part of an RTC coordinator 1130, e.g., as described below.

In one example, RTC coordinator 1130 may include a central management entity, which may be implemented, for example, outside the vehicles 1100.

In some demonstrative aspects, RTC coordinator 1130 may be configured to coordinate RTC settings for vehicles 1100, for example, in a plurality of road segments 1103, e.g., as described below.

In some demonstrative aspects, RTC coordinator 1130 may include the processor 1124, e.g., as described below.

In some demonstrative aspects, RTC coordinator 1130 may include a communication interface 1132, which may be configured to transmit the RTC setting information 1128 to the vehicle 1100, e.g., as described below.

In some demonstrative aspects, processor 1124 may be configured to process location information received from the vehicle 1100, for example, to determine the road segment 1103 for the vehicle 1100, e.g., as described below.

In some demonstrative aspects, processor 1124 may be configured to configure the RTC setting information 1128 for the vehicle 1100, for example, based on the RTC allocation 1113 corresponding to the road segment 1103 for the vehicle 1100, e.g., as described below.

In some demonstrative aspects, RTC coordinator 1130 may be configured to coordinate RTC settings for vehicles 1100 in a plurality of road segments 1103, e.g., as described below.

In some demonstrative aspects, RTC coordinator 1130 and the vehicle controller 1150 of vehicle 1100 may be capable to communicate, for example, in a reliable manner, and/or with a low latency.

In some demonstrative aspects, an RTC setting session between the RTC coordinator 1130 and the vehicle controller 1150 may be initiated, for example, by the vehicle controller 1150, and/or by RTC coordinator 1130.

In some demonstrative aspects, RTC coordinator 1130 may be configured to receive information from vehicle controller 1150. In one example, RTC coordinator 1130 may request at least part of the information from the vehicle controller 1150. In another example, RTC coordinator 1130 may receive at least part of the information from the vehicle controller 1150, e.g., even without request.

In some demonstrative aspects, the information provided from vehicle controller 1150 to RTC coordinator 1130 may include, for example, location information corresponding to a vehicle location of vehicle 1100, route information corresponding to a driving route of vehicle 1100, e.g., based on a navigation route or turning indications, radar radio information of the one or more radar radios 1110, and/or any other additional or alternative information. For example, the radar radio information may include, for example, information of spatial poses of the one or more radar radios 1110, and/or one or more parameters and/or attributes of the one or more radar radios 1110.

In some demonstrative aspects, RTC coordinator 1130 may be configured to identify a lane of vehicle 1100 and a road segment, e.g., the road segment 1103, corresponding to the vehicle 1100, for example, based on the location information from vehicle 1100.

In some demonstrative aspects, RTC coordinator 1130 may be configured to determine a set of RTC settings for the one or more radar radios 1110 of vehicle 1100, for example, based on RTC allocation information in map information of a map segment corresponding to the road segment 1103.

In one example, the map segment may include a map tile of a relevant map, and/or a set of rules with a geographic validity, e.g., between junctions, roundabout, intersections, and/or the like.

In some demonstrative aspects, RTC coordinator 1130 may be configured to determine the set of RTC settings for the one or more radar radios 1110 of vehicle 1100, for example, based on the radar radio information, e.g., based on the spatial poses of the one or more radar radios 1110.

In some demonstrative aspects, RTC coordinator 1130 may be configured to instruct the vehicle controller 1150 with respect to assignment of a particular RTC setting from the set of RTC settings to a specific radar radio 1110.

In some demonstrative aspects, RTC coordinator 1130 may be configured to instruct the one or more radar radios 1110, for example, to perform one or more measurements, for example, to dynamically determine a waveform subclass.

In some demonstrative aspects, RTC coordinator 1130 may be configured to close the setting session, for example, once vehicle 1100 is parked or in case no change to the set of RTC settings for the vehicle 1100 is required, e.g., in case of a long highway driving scenario.

In some demonstrative aspects, an RTC allocation mechanism may be configured according to one or more automation techniques, for example, to provide a technical solution to support automation of determining the RTC setting 1125 for a radar radio 1110, e.g., as described below.

In some demonstrative aspects, the RTC allocation mechanism may be configured to determine the RTC setting 1125 for the radar radio 1110, for example, based on road topology information.

In some demonstrative aspects, the road topology information may include information of a road topology at the road segment 1103, and a LoS blocking at the road segment 1103, for example, due to height differences and/or land cover, e.g., as described below.

In some demonstrative aspects, the road topology information may include two-dimensional (2D) road topology information, and/or three-dimensional (3D) road topology information.

In some demonstrative aspects, the road topology information may include road trace information corresponding to road traces in the road segment 1103.

In some demonstrative aspects, the road topology information may include direction information corresponding to a driving direction in the road segment 1103, e.g., per lane.

In some demonstrative aspects, the road topology information may include land cover information corresponding to a land cover at the road segment 1103.

In some demonstrative aspects, the road topology information may include a number of lanes at the road segment 1103.

In some demonstrative aspects, the road topology information may include ramps and interchanges information corresponding to ramps and interchanges at the road segment 1103.

In some demonstrative aspects, the LoS blocking information may include information with respect to a land cover at the road segment 1103.

In some demonstrative aspects, the LoS blocking information may include information with respect to height differences at the road segment 1103, which may cause LoS blocking.

In some demonstrative aspects, the road topology information may include any other additional or alternative information corresponding to the road topology.

In some demonstrative aspects, the RTC allocation mechanism may be configured to determine the RTC setting 1125 for the radar radio 1110 of the vehicle, for example, based on an installation type of vehicle 1100.

In some demonstrative aspects, the installation type of vehicle 1100 may include spatial pose information corresponding to spatial poses of one or more radar radios 1110, and/or RU information of the one or more radar radios 1110 of the vehicle 1100.

In one example, the RU information may include information of a radar radio, which may be required by the RTC allocation mechanism.

In some demonstrative aspects, the spatial pose information may include vehicle installation positions of radar radios 1110 of the vehicle 1100, and/or a generic partitioning of the radar radios 1110 of the vehicle 1100, for example, per an orientation and/or a FoV of a radar radio 1110.

In some demonstrative aspects, the spatial pose information may include orientations of the radar radios of the vehicle.

In some demonstrative aspects, the spatial pose information may include a FoV, e.g., in one or both of Azimuth (Az) and Elevation (El) of the radar radios 1110 of the vehicle 1100.

In some demonstrative aspects, the RU information may include max range assumption of the radar radios 1110 of the vehicle 1100.

In some demonstrative aspects, the RU information may include information of one or more RTCs supported by the radar radios 1110 of the vehicle 1100.

In some demonstrative aspects, the RU information may include any other suitable additional or alternative parameters.

In some demonstrative aspects, processor 1124 may be configured to determine the RTC setting 1125 for the radar radio 1110, for example, based on an RTC separation strength.

In one example, the RTC separation strength may define a strength of separation between waveforms according to different RTC settings.

In one example, the RTC separation strength may be referred to as a distance in the signals' space.

In one example, a first chirp may have a first slope and a second chirp may have a second slope different from the first slope.

For example, there may be a first RTC separation strength between the first chirp and the second chirp, for example, when the first slope is opposite to the second slope.

For example, there may be a second RTC separation strength between the first chirp and the second chirp, for example, when the first slope and the second slope are close to each other.

For example, the first RTC separation strength may be greater than the second RTC separation strength.

In one example, there may be substantially zero time overlap, for example, when time synchronization between vehicles, e.g., of a fleet conforming to a same standard, are truly orthogonal, which may correspond to a first RTC separation strength.

In another example, there may be some overlap, e.g., about 10%, in the time synchronization between the vehicles, which may cause a degradation e.g., of about 10 dB, to the interfering source.

In some demonstrative aspects, the RTC allocation mechanism may be configured to determine the RTC setting for the radar radio 1110 of the vehicle 1100, for example, based on a separation strength rule, e.g., as described below.

In some demonstrative aspects, the separation strength rule may define using RTC settings with a strong separation, for example, to avoid a direct interference, e.g., between front radar units in opposite driving directions.

In some demonstrative aspects, the separation strength rule may define utilizing RTC settings with a weak separation, for example, for front radar radios of vehicles traveling in the same direction, e.g., along the same lane.

In some demonstrative aspects, the separation strength rule may define utilizing RTC settings with a weak separation for corner radar radios of different vehicles along the same lane, e.g., where their boresight is “looking into” a similar direction with a FoV overlap.

For example, the RTC allocation mechanism may utilize the RTC settings with a weak separation, for example, for corner radar radios along the same line, for example, as the radar equation and beam pattern may attenuate an interfering signal.

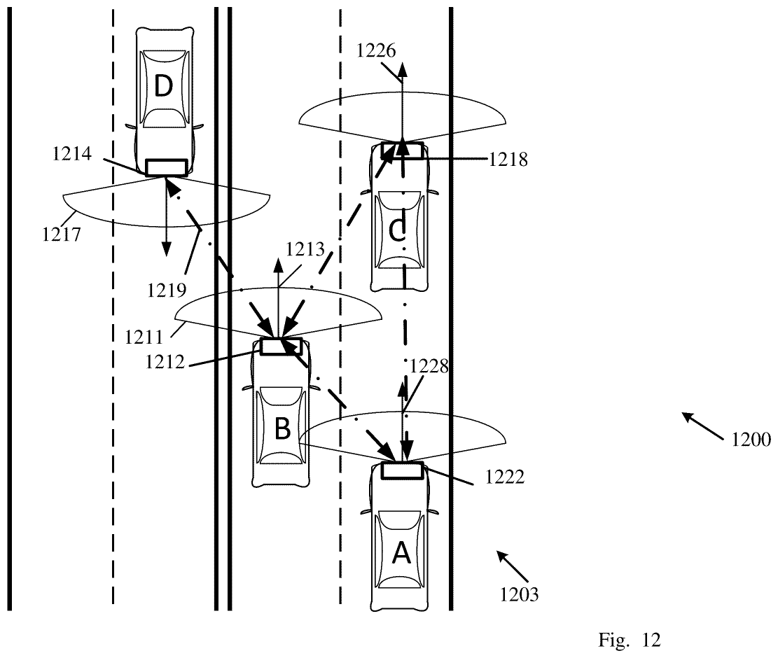

Reference is made to FIG. 12, which schematically illustrates implementation of an RTC allocation 1200, in accordance with some demonstrative aspects.

In some demonstrative aspects, RTC allocation 1200 may correspond to a road segment 1203, e.g., a highway.

In one example, the implementation of the RTC allocation 1200 may relate to front-looking radar radios in a highway scenario.

In some demonstrative aspects, RTC allocation 1200 may be configured, for example, based on a direct-interference avoidance criterion, for example, a direct blinding prevention technique, e.g., as described below.

In some demonstrative aspects, the direct-interference avoidance criterion may be configured to avoid direct interference caused by radar signals transmitted from a first radar radio of a first vehicle in the road segment 1203 and received directly by a second radar radio of a second vehicle in the road segment 1203.

In one example, the direct-interference avoidance criterion may be configured to avoid direct interference caused by radar signals transmitted from a first radar radio 1212 of a first vehicle, denoted B, in the road segment 1203 and received directly by a second radar radio 1214 of a second vehicle, denoted D, in the road segment 1203.

In some demonstrative aspects, the direct-interference avoidance criterion may be configured to selectively allow or prohibit assignment of a same RTC setting to a first radar radio and a second radar radio, for example, based on a LOS rule, e.g., as described below.

In some demonstrative aspects, the LoS rule may require that a LoS between the first radar radio and the second radar radio according to the road topology at the road segment 1203 may not pass through both a first FoV of the first radar radio 1212 and a second FoV of the second radar radio 1214.

In some demonstrative aspects, the LoS rule may require that the LoS between two radar radios sharing a same RTC setting may not pass through the FoVs of the two radar radios.

In some demonstrative aspects, the direct-interference avoidance criterion may be configured to selectively allow or prohibit assignment of a same RTC setting to a first radar radio and a second radar radio, for example, based on a direct-interference avoidance boresight rule, e.g., as described below.

In some demonstrative aspects, the direct-interference avoidance boresight rule may require that a first boresight of the first radar radio according to the road topology at the road segment 1203 may be within a predefined margin from a second boresight of the second radar radio according to the road topology at the road segment 1203.

In one example, the direct-interference avoidance boresight rule may require that both boresights of two radar radios sharing a same RTC setting may be required to look substantially at a same direction, e.g., within a predefined margin.

In some demonstrative aspects, the predefined margin implemented by the direct-interference avoidance boresight rule may be based, for example, on the road topology at the road segment 1203, e.g., as described below.

In some demonstrative aspects, the predefined margin implemented by the direct-interference avoidance boresight rule may include a first predefined margin, which may be implemented, for example, when the road topology at the road segment 1203, e.g., as shown in FIG. 12, includes a driving route, which is generally straight or which has a relatively small curvature, e.g., a curvature below a predefined curvature threshold.

For example, the first predefined margin may be relatively small, e.g., a margin of about +/−5 degrees (deg), +/−10 deg, or any other suitable value.

In some demonstrative aspects, the predefined margin implemented by the direct-interference avoidance boresight rule may include a second predefined margin, which may be implemented, for example, when the road topology includes a driving route, which has a relatively large curvature, e.g., a curvature above the predefined curvature threshold.

For example, the second predefined margin may be relatively large, e.g., a margin of about +/−30 degrees (deg), +/−45 deg, or any other suitable value.

In one example, the LoS rule and/or the direct-interference avoidance boresight rule may be applicable within an effective range of an interfering RU, which may be a function of a radar maximum range, and/or may be different between corner radar radios and front radar radios.

In some demonstrative aspects, the RTC allocation 1200 may be configured to allocate one or more RTC settings to one or more radar radios, for example, based on the LoS rule, e.g., corresponding to a LoS between a radar radio and one or more other radar radios sharing the same RTC setting.

In some demonstrative aspects, the RTC allocation 1200 may be configured to allocate one or more RTC settings to one or more radar radios, for example, based on the direct-interference avoidance boresight rule, e.g., relating to a boresight direction of the radar radios.

In some demonstrative aspects, the RTC allocation 1200 may be configured to allocate one or more RTC settings to one or more radar radios, for example, based on a rule requiring that radar radios that meet the direct-interference avoidance boresight rule and/or the LoS rule may, e.g., should, share a same RTC setting.

In some demonstrative aspects, as shown in FIG. 12, the RTC allocation 1200 corresponding to the road segment 1203 may be configured, for example, to prohibit allocation of a same RTC setting to the first radar radio 1212 of the vehicle B, which is in a first lane segment of a first lane having a first driving direction, and to the second radar radio 1214 of the vehicle D, which is in a second lane segment of a second lane having a second driving direction, for example, in case that a LoS 1219 between the first lane segment and the second lane segment is clear according to the road topology at the road segment 1203. For example, the LoS 1219 between the first vehicle B and the second vehicle D may be clear, and may pass through both a first FoV 1211 of the first radar radio 1212 and a second FoV 1217 of the second radar radio 1214.

In some demonstrative aspects, as shown in FIG. 12, a vehicle, denoted A, the vehicle B, and a vehicle, denoted C, may be allowed to use a same RTC setting, e.g., for front radar radios, for example, based on a determination that their boresight directions of the front radar radios are aligned, and/or based on a determination that the LoS between any two members of this set of vehicles is not included in both FoVs of the two members.

In some demonstrative aspects, as shown in FIG. 12, the RTC allocation 1200 corresponding to the road segment 1203 may be configured, for example, to allow allocation of a same RTC setting to the radio 1212 of the vehicle B, to a radio 1218 of the vehicle C, and to a radio 1222 of the vehicle A, for example, since the LoS between any two members of this set of radar radios is not included in both FoVs of the two members.

In some demonstrative aspects, as shown in FIG. 12, the RTC allocation 1200 corresponding to the road segment 1203 may be configured, for example, to allow allocation of a same RTC setting to the radio 1212 of the vehicle B, to a radio 1218 of the vehicle C, and to a radio 1222 of the vehicle A, for example, as the boresight 1213 of the radar radio 1212, a boresight 1226 of the radar radio 1218 of the third vehicle C, and a boresight 1228 of the radar radio 1222 of the vehicle D may be substantially in a same direction, e.g., within a predefined margin.

For example, as shown in FIG. 12, the vehicles D and B may be required to use different RTC settings, for example, based on the determination that their boresight directions are facing each other, and the LoS 1219 between the vehicles D and B is included in both FoVs of the vehicles D and B.

For example, as shown in FIG. 12, the vehicles D and A may be required to use different RTC settings, for example, based on the determination that their boresight directions are facing each other, and/or the LoS between the vehicles D and A is included in both FoVs of the vehicles D and A.

In some demonstrative aspects, the RTC allocation 1200 may be configured to use the road topology as a baseline of RTC optimization, for example, to provide a technical solution to reduce, e.g., minimize, interference between radar radios.

In some demonstrative aspects, the RTC allocation 1200 may be configured to allocate RTC settings, for example, based on the road topology, and a land-cover, e.g., in case of LoS blocking.

For example, in case a LoS between two or more radar radios is blocked by a land-cover, e.g., a building or an interchange, a same RTC setting may be allocated to the two or more radar radios, e.g., based on the direct-interference avoidance criterion defined above.

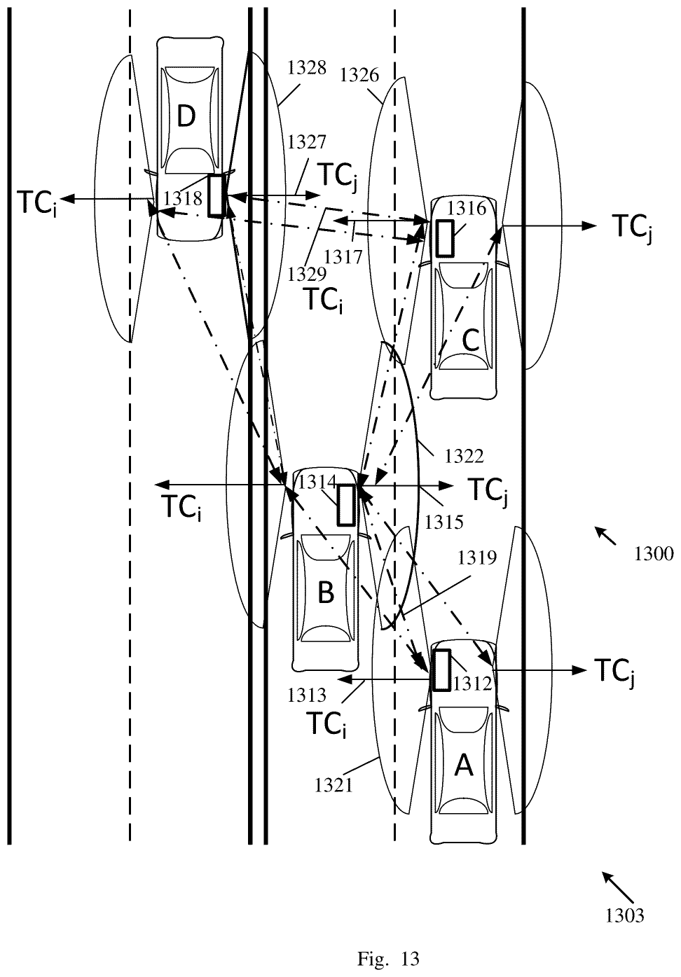

Reference is made to FIG. 13, which schematically illustrates implementation of an RTC allocation 1300, in accordance with some demonstrative aspects.

In some demonstrative aspects, RTC allocation 1300 may correspond to a road segment 1303, e.g., a highway.

In one example, the implementation of the RTC allocation 1300 may relate to side-looking radar radios in a highway scenario.

In some demonstrative aspects, RTC allocation 1300 corresponding to the road segment 1303 may be configured, for example, based on the direct-interference avoidance criterion, for example, the direct blinding prevention technique, e.g., as described below.

In some demonstrative aspects, the direct-interference avoidance criterion may be configured to avoid direct interference caused by radar signals transmitted from a first corner radar radio of a first vehicle in the road segment 1303 and received directly by a second corner radar radio of a second vehicle in the road segment 1303.

In one example, the direct-interference avoidance criterion may be configured to avoid direct interference caused by radar signals transmitted from a first radar radio 1312 of a first vehicle, denoted A, in the road segment 1303, and received directly by a second corner radar radio 1314 of a second vehicle, denoted B, in the road segment 1303.

In some demonstrative aspects, the direct-interference avoidance criterion may be configured to selectively allow or prohibit assignment of a same RTC setting to the first corner radar radio and the second corner radar radio, for example, based on the direct-interference avoidance boresight rule and/or the LoS rule.

In some demonstrative aspects, the RTC allocation 1300 may be configured to allocate one or more RTC settings to one or more radar radios, for example, based on a rule requiring that radar radios that meet the direct-interference avoidance boresight rule and/or the LoS rule may, e.g., should, share a same RTC setting.

In some demonstrative aspects, as shown in FIG. 13, the RTC allocation 1300 corresponding to the road segment 1303 may be configured, for example, to prohibit allocation of a same RTC setting to the first radar radio 1312 of the vehicle A, and to the second radar radio 1314 of the vehicle B, for example, in case a LoS 1319 between the first vehicle A and the second vehicle B is clear and passes through both a first FoV 1321 of the first radar radio 1312 and a second FoV 1322 of the second radar radio 1314.

In some demonstrative aspects, as shown in FIG. 13, the RTC allocation 1300 corresponding to the road segment 1303 may be configured, for example, to prohibit allocation of a same RTC setting to a third radar radio 1316 of a third vehicle, denoted C, and to a fourth radar radio 1318 of a fourth vehicle, denoted D, for example, in case a LoS 1329 between the first vehicle A and the second vehicle B is clear and passes through both a third FoV 1326 of the third radar radio 1316 and a fourth FoV 1328 of the fourth radar radio 1318.

In some demonstrative aspects, as shown in FIG. 13, the RTC allocation 1300 corresponding to the road segment 1303 may be configured, for example, to allow allocation of a same RTC setting to the first radio 1312 of the vehicle A, and to the third radio 1316 of the vehicle C, for example, in case a boresight 1313 of the first radar radio 1312, and a boresight 1317 of the third radar radio 1316 are sustainably in the same direction, e.g., within a predefined margin.

In some demonstrative aspects, as shown in FIG. 13, the RTC allocation 1300 corresponding to the road segment 1303 may be configured, for example, to allow allocation of a same RTC setting to the second radio 1314 of the vehicle B, and to the fourth radio 1318 of the vehicle D, for example, in case a boresight 1315 of the second radar radio 1314, and a boresight 1327 of the fourth radar radio 1318 are sustainably in the same direction, e.g., within a predefined margin.

For example, as shown in FIG. 13, the RTC allocation 1300 corresponding to the road segment 1303 may be configured, for example, to allow all the “left looking” radar radios in road segment 1303 to have a same first RTC settings, denoted TCi.

For example, as shown in FIG. 13, the RTC allocation 1300 corresponding to the road segment 1303 may be configured, for example, to allow all the “right looking” radar radios in road segment 1303 to have a same second RTC settings, denoted TCj.

According to this example, the RTC allocation 1300 corresponding to the road segment 1303 may be configured, for example, such that two corner radar radios, which have a LoS included in both FoVs of the two corner radar radios, may have different RTC settings. For example, one radar radio may have the first RTC settings TCi, and the other radar radio may have the second RTC settings TCj.

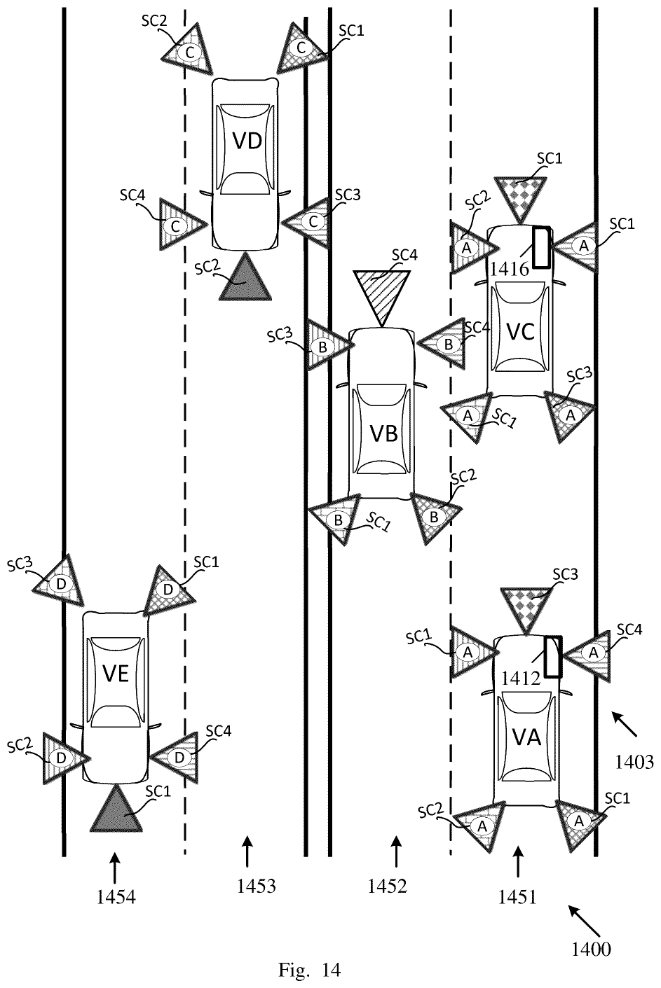

Reference is made to FIG. 14, which schematically illustrates an RTC allocation 1400, in accordance with some demonstrative aspects.

In one example, the RTC allocation 1400 may relate to radar radios in a highway scenario.

In some demonstrative aspects, RTC allocation 1400 may be based on a lane configuration of one or more lanes at the road segment 1403, e.g., a highway.

In some demonstrative aspects, RTC allocation 1400 corresponding to the road segment 1403 may be configured, for example, based on an indirect-interference avoidance criterion, for example, a non-direct interference prevention technique, e.g., as described below.

In some demonstrative aspects, the indirect-interference avoidance criterion may be configured to avoid indirect interference caused by radar signals transmitted from a first radar radio of a first vehicle in the road segment 1403 and received, via reflection from one or more objects, by a second radar radio of a second vehicle in the road segment 1403.

In some demonstrative aspects, the indirect-interference avoidance criterion may be configured to extend the direct-interference avoidance criterion, for example, to prevent non-direct effects, which may occur, for example, when an IRU illuminates objects in a field of view of a VRU, which may cause confusion with respect to many false reflections.

In some demonstrative aspects, the indirect-interference avoidance criterion may be configured to according to one or more, e.g., some or all, rules, e.g., as described below.

In some demonstrative aspects, the indirect-interference avoidance criterion may be configured to allow or prohibit assignment of a same RTC setting to a first radar radio and a second radar radio according to an indirect-interference avoidance boresight rule, e.g., as described below.

In some demonstrative aspects, the indirect-interference avoidance boresight rule may be configured, for example, to identify whether or not a first boresight of the first radar radio according to the road topology in the road segment 1403 is within a predefined margin from a second boresight of the second radar radio according to the road topology in the road segment 1403, e.g., as described below.

In some demonstrative aspects, the indirect-interference avoidance criterion may be configured to prohibit assignment of a same RTC setting to the first radar radio and the second radar radio, for example, if the first boresight of the first radar radio according to the road topology in the road segment 1403 is within a predefined margin from a second boresight of the second radar radio according to the road topology in the road segment 1403.

In some demonstrative aspects, the predefined margin implemented by the indirect-interference avoidance boresight rule may be based, for example, on the road topology at the road segment 1403, e.g., as described below.

In some demonstrative aspects, the predefined margin implemented by the indirect-interference avoidance boresight rule may include a first predefined margin, which may be implemented, for example, when the road topology at the road segment 1403, e.g., as shown in FIG. 14, includes a driving route, which is generally straight or which has a relatively small curvature, e.g., a curvature below a predefined curvature threshold.

For example, the first predefined margin may be relatively small, e.g., a margin of about +/−5 degrees (deg), +/−10 deg, or any other suitable value.

In some demonstrative aspects, the predefined margin implemented by the direct-interference avoidance boresight rule may include a second predefined margin, which may be implemented, for example, when the road topology includes a driving route, which has a relatively large curvature, e.g., a curvature above the predefined curvature threshold.

For example, the second predefined margin may be relatively large, e.g., a margin of about +/−30 degrees (deg), +/−45 deg, or any other suitable value.

In some demonstrative aspects, the indirect-interference avoidance criterion may be configured to define that different lanes of road segment 1403 may be assigned with different sets of RTC settings, for example, within a maximal (Max) range, or a fraction of the Max range, of an interfering RU.

In some demonstrative aspects, the indirect-interference avoidance criterion may be configured to define that vehicles of a same lane may be assigned, for example, according to an along-lane allocation rule (also referred to as Waveform (WF) subclass rule”), e.g., as described below.

In some demonstrative aspects, the RTC allocation 1400 corresponding to the road segment 1403 may be configured, for example, to assign a plurality of sets of RTC settings to a plurality of lanes in the road segment 1403.

In some demonstrative aspects, as shown in FIG. 14, the plurality of sets of RTC settings may include a first set of RTC settings, denoted A, for a first lane 1451.

In some demonstrative aspects, as shown in FIG. 14, the plurality of sets of RTC settings may include a second set of RTC settings, denoted B, for a second lane 1452.

In some demonstrative aspects, the second set of RTC settings B may be different from the first set of RTC settings A.

In some demonstrative aspects, as shown in FIG. 14, the plurality of sets of RTC settings may include a third set of RTC settings, denoted C, for a third lane 1453.

In some demonstrative aspects, the third set of RTC settings C may be different from the first set of RTC settings A and the second set of RTC settings B.

In some demonstrative aspects, as shown in FIG. 14, the plurality of sets of RTC settings may include a fourth set of RTC settings, denoted D, for a fourth lane 1454.

In some demonstrative aspects, the fourth set of RTC settings D may be different from the third set of RTC settings C, the first set of RTC settings A, and the second set of RTC settings B.

In some demonstrative aspects, the RTC allocation 1400 corresponding to the road segment 1403 may be configured, for example, to reuse one or more, e.g., some or all, of the plurality of sets of RTC settings, for example, with respect to a plurality of lane portions along the lanes, e.g., as described below.

For example, the RTC allocation 1400 corresponding to the road segment 1403 may be configured, for example, to reuse the set of RTC settings A, for example, with respect to a plurality of lane portions along the lane 1451.

For example, the RTC allocation 1400 corresponding to the road segment 1403 may be configured, for example, to reuse the set of RTC settings A, for example, by repeatedly using the same the set of RTC settings A for two or more, e.g., for each, of the plurality of lane portions along the lane 1451.

For example, the RTC allocation 1400 corresponding to the road segment 1403 may be configured, for example, such that a length of a lane portion of the plurality of lane portions along the lane 1451 is based on a count of predefined RTC settings in the set of RTC settings A.

For example, the RTC allocation 1400 corresponding to the road segment 1403 may be configured, for example, to reuse the set of RTC settings B, for example, with respect to a plurality of lane portions along the lane 1452.

For example, the RTC allocation 1400 corresponding to the road segment 1403 may be configured, for example, to reuse the set of RTC settings B, for example, by repeatedly using the same the set of RTC settings B for two or more, e.g., for each, of the plurality of lane portions along the lane 1452.

For example, the RTC allocation 1400 corresponding to the road segment 1403 may be configured, for example, such that a length of a lane portion of the plurality of lane portions along the lane 1452 is based on a count of predefined RTC settings in the set of RTC settings B.

For example, the RTC allocation 1400 corresponding to the road segment 1403 may be configured, for example, to reuse the set of RTC settings C, for example, with respect to a plurality of lane portions along the lane 1453.

For example, the RTC allocation 1400 corresponding to the road segment 1403 may be configured, for example, to reuse the set of RTC settings C, for example, by repeatedly using the same the set of RTC settings C for two or more, e.g., for each, of the plurality of lane portions along the lane 1453.

For example, the RTC allocation 1400 corresponding to the road segment 1403 may be configured, for example, such that a length of a lane portion of the plurality of lane portions along the lane 1453 is based on a count of predefined RTC settings in the set of RTC settings C.

For example, the RTC allocation 1400 corresponding to the road segment 1403 may be configured, for example, to reuse the set of RTC settings D, for example, with respect to a plurality of lane portions along the lane 1454.

For example, the RTC allocation 1400 corresponding to the road segment 1403 may be configured, for example, to reuse the set of RTC settings D, for example, by repeatedly using the same the set of RTC settings D for two or more, e.g., for each, of the plurality of lane portions along the lane 1454.

For example, the RTC allocation 1400 corresponding to the road segment 1403 may be configured, for example, such that a length of a lane portion of the plurality of lane portions along the lane 1454 is based on a count of predefined RTC settings in the set of RTC settings D.

In some demonstrative aspects, a processor, e.g., processor 1124 (FIG. 11), may be configured to select for a vehicle a particular set of RTC settings from the plurality of sets of RTC settings for road segment 1403, for example, based on a particular lane of road segment 1403 to be driven by the vehicle.

In one example, the processor, e.g., processor 1124 (FIG. 11), may be configured to select the set of RTC settings A, for a vehicle, denoted VA, for example, based on the particular lane 1451 of road segment 1403 for the vehicle VA.

In another example, the processor, e.g., processor 1124 (FIG. 11), may be configured to select the set of RTC settings A, for a vehicle, denoted VC, for example, based on the particular lane 1451 of road segment 1403 for the vehicle VC.

In another example, the processor, e.g., processor 1124 (FIG. 11), may be configured to select the set of RTC settings B, for a vehicle, denoted VB, for example, based on the particular lane 1452 of road segment 1403 for the vehicle VB.

In another example, the processor, e.g., processor 1124 (FIG. 11), may be configured to select the set of RTC settings C, for a vehicle, denoted VD, for example, based on the particular lane 1453 of road segment 1403 for the vehicle VD.

In another example, the processor, e.g., processor 1124 (FIG. 11), may be configured to select the set of RTC settings D, for a vehicle, denoted VE, for example, based on the particular lane 1454 of road segment 1403 for the vehicle VE.

In some demonstrative aspects, a processor, e.g., processor 1124 (FIG. 11), may be configured to determine an along-lane setting for a vehicle, which may be configured to define a setting of at least one RTC parameter, for example, based on a location of the vehicle along a lane, for example, according to the along-lane allocation rule.

In some demonstrative aspects, as shown in FIG. 14, RTC allocation 1400 may define a plurality of predefined along-lane settings for the at least one RTC parameter.

In some demonstrative aspects, a processor, e.g., processor 1124 (FIG. 11), may be configured to randomly select a particular along-lane setting from the plurality of predefined along-lane settings, and to configure the RTC setting to include the particular along-lane setting for the at least one RTC parameter.

In one example, as shown in FIG. 14, the processor, e.g., processor 1124 (FIG. 11), may be configured to select a first particular along-lane setting from the plurality of predefined along-lane settings of the set of RTC settings A, e.g., a subclass 4 (SC4), for example, for a radar radio 1412 of the vehicle VA along the lane 1451, for example, based on a first location of the vehicle VA along the lane 1451.

In one example, as shown in FIG. 14, the processor, e.g., processor 1124 (FIG. 11), may be configured to select a second particular along-lane setting from the plurality of predefined along-lane settings the set of RTC settings A, e.g., a subclass 1 (SC1), for example, for a radar radio 1416 of the vehicle VC along the lane 1451, for example, based on a second location of the vehicle VC along the lane 1451.

In some demonstrative aspects, an RTC allocation, for example, RTC allocation 1400, may be implemented with respect to a scenario of a highway or a straight road.

For example, as shown in FIG. 14, the road topology of road segment 1403 may be relatively simple.

For example, as shown in FIG. 14, the RTC allocation 1400 may be implemented with respect to a five-radar-unit topology. In other aspects, the RTC allocation 1400 may be implemented with any other number of radar radios, e.g., greater than or less than five.

For example, the RTC allocation 1400 may be configured to relate to a US-based driving direction. In other aspects, the RTC allocation 1400 may similarly be expanded to the UK driving direction.

For example, the configuration of the RTC allocation 1400 may prevent direct blinding. However, in case it may be required to prevent non-direct reflections from objects, each lane may have to be provided with a different allocation. For example, the vehicles VA, VB, VC, VD, and VE may each be allocated with a different set of RTC settings.

In some demonstrative aspects, RTC allocation 1400 may be defined by RTC allocation information, e.g., as described below.

In some demonstrative aspects, the RTC allocation information may be provided as part of map information of a map segment corresponding to the road segment 1403, e.g., as described below.

In other aspects, the RTC allocation information may be provided as part of any other information and/or in any other format.

In some demonstrative aspects, the RTC allocation information may include a plurality of RTC entries corresponding to a plurality of scenarios, e.g., as described below.

In some demonstrative aspects, an RTC entry corresponding to a scenario may include scenario-based RTC information to define a scenario-based setting of one or more RTC parameters for the scenario, e.g., as described below.

In some demonstrative aspects, the plurality of RTC entries may include a first RTC entry corresponding to a first scenario and a second RTC entry corresponding to a second scenario, e.g., as described below.

In some demonstrative aspects, the first RTC entry may include first scenario-based RTC information to define a first setting of the one or more RTC parameters for the first scenario, e.g., as described below.

In some demonstrative aspects, the second RTC entry may include second scenario-based RTC information to define a second setting, e.g., different from the first setting, of the one or more RTC parameters for the second scenario, e.g., as described below.

In some demonstrative aspects, the RTC entry may include scenario information to define the scenario, for example, based on a lane identifier, e.g., as described below.

In some demonstrative aspects, the RTC entry may include scenario information to define the scenario, for example, based on a radar installation spatial pose, e.g., as described below.

In one example, the RTC allocation information corresponding to road segment 1403 may include one of more of the following RTC entries:

TABLE 1

| | Lane | Cross | Along |
|---|---|---|---|
| Radar Position | ID | lane | Lane |
| Front | 1 | Fc1, TS1, | WF_subclass_rule_f |
| | | WF_class_1 | |
| Front | 2 | Fc1, TS2, | WF_subclass_rule_f |
| | | WF_class_1 | |
| Front | 3 | Fc1, TS3, | WF_subclass_rule_f |
| | | WF_class_1 | |
| Front | 4 | Fc1, TS4, | WF_subclass_rule_f |
| | | WF_class_1 | |
| Corner_Front_Right | 1 | Fc2, TS1, | WF_subclass_rule_c |
| | | WF_class_1 | |
| Corner_Front_Right | 2 | Fc2, TS2, | WF_subclass_rule_c |
| | | WF_class_1 | |
| Corner_Front_Right | 3 | Fc3, TS3, | WF_subclass_rule_c |
| | | WF_class_1 | |
| Corner_Front_Right | 4 | Fc3, TS4, | WF_subclass_rule_c |
| | | WF_class_1 | |

In one example, Table 1 may include RTC entries for a front radar radio of a vehicle, and a front-right-corner radar radio of the vehicle. In another example, Table 1 may be expanded to include additional radar locations, e.g., for all radar radios of the vehicle.

In one example, Table 1 may include RTC entries for four lanes, denoted 1-4, which may be included in road segment 1403. In another example, Table 1 may be expanded to include more than four lanes, for example, for a road segment having more than 4 lanes.

For example, Table 1 may include RTC entries for the lanes 1451, 1452, 1453, 1454, corresponding to the lanes 1-4, respectively.

In some demonstrative aspects, a plurality of non-overlapping center frequencies, denoted Fci, e.g., Fc1, Fc2 and/or Fc3, may be defined. For example, Fc1, Fc2 and/or Fc3 may define a radar RF BW of 250 MHz, and center frequencies of 76 GHz+{125 MHz, 375 MHz, 625 MHz}, respectively.

In some demonstrative aspects, an i-th Time Slot (Ts) of a frame, denoted TSi, may be defined, for example, in the form of T0+Frame length. For example, if a radar operates at a rate of 20 Frames Per Second (FPS), and a frame length of the radar is 10 milliseconds (ms), there may be 5 TS available and I={1, 2, 3, 4, 5}. For example, TO may be set according to a sync method, e.g., Ethernet based, Global Positioning System (GPS) based and/or the like. For example, the sync method may be a second boundary or a minute boundary of a sub second accurate real time clock.

In some demonstrative aspects, an i-th waveform (WF) class, denoted, WF_class_i, may include waveforms, which may be configured with a high-level of separation strength from other waveform classes. For example, the waveform class may include a code sequence, a chirp slope angle, and/or the like. For example, a first waveform class may include a chirp-up and a second waveform class may include a chirp-down, for example, for a signal space of two members. For example, corner radar units of a same side of the vehicle may be separated by the waveform class.

In some demonstrative aspects, a WF subclass rule, denoted WF_subclass_rule_x, may be configured to define a waveform subclass of a waveform class. For example, the waveform subclass may include a relatively low-level of separation strength between waveforms, e.g., compared to the separation strength between waveform classes. For example, the waveform subclass may be a difference within the waveform class with a lower separation strength compared to the waveform class.

In one example, the waveform subclass may relate to a frame structure, code, and/or any other separation method. For example, the waveform subclass may change a number of chirps in a frame. According to this example, different waveform subclasses may have a different chirp slope, but may have a same ‘direction’ as the other waveform subclasses of the waveform class.

For example, the waveform class may include a chirp up or chirp down, and the waveform subclass may include 128 or 256 chirps per frame, for example, when all frames are defined to have substantially the same duration.

In some demonstrative aspects, the waveform subclass may define an along-the-lane rule, for example, for RTC assignments along a same lane, e.g., as described below.

For example, the waveform class may include a chirp up or chirp down, which may be assigned to two different lanes, and the waveform subclass may include 128 or 256 chirps per frame, which may be assigned to two adjacent vehicles along a same lane.

In some demonstrative aspects, a processor, e.g., processor 1124 (FIG. 11), may be configured to determine a waveform subclass for a radar radio of a vehicle, for example, based on a waveform-subclass allocation rule, e.g., as described below.

In some demonstrative aspects, an RTC coordinator, e.g., RTC coordinator 1130 (FIG. 11), may be configured to determine a waveform subclass for a radar radio of a vehicle, for example, based on location information of the vehicle, which may be received from the vehicle.

In some demonstrative aspects, the RTC coordinator may transmit information to identify the waveform subclass to the vehicle, for example, in response to receipt of the location information form the vehicle.

In one example, this procedure may require a relatively reliable communication and/or a low-latency round trip between the RTC coordinator and the vehicle.

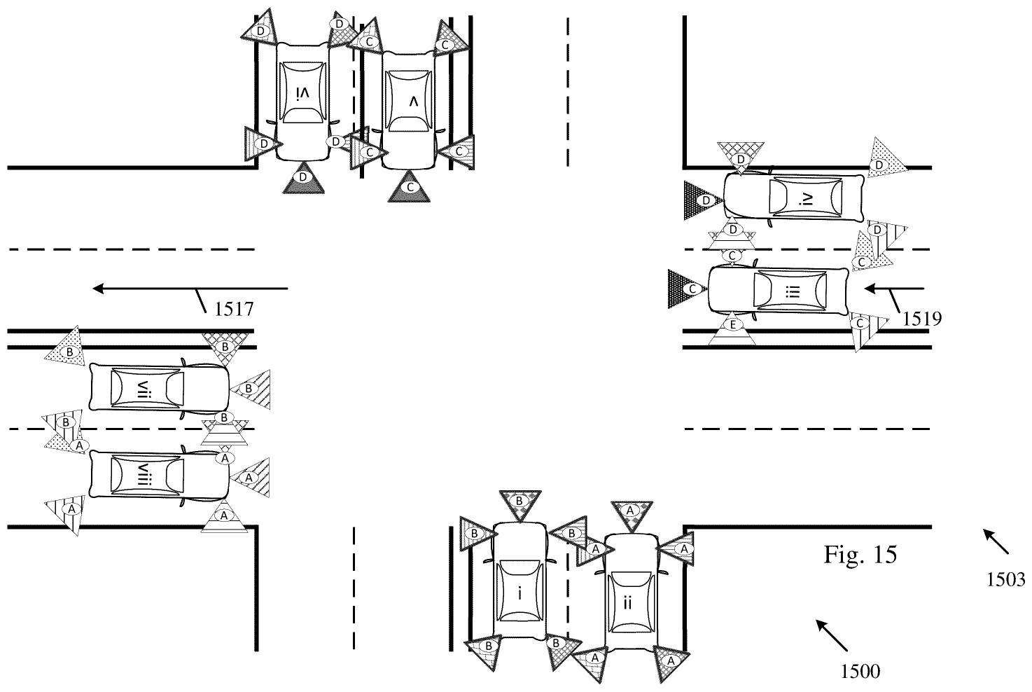

Reference is made to FIG. 15, which schematically illustrates an RTC allocation 1500 corresponding to a road segment 1503, in accordance with some demonstrative aspects.

For example, the road segment 1503 may include an intersection.

In some demonstrative aspects, RTC allocation 1500 may be based on an interchange topology of the intersection at the road segment 1503.

In some demonstrative aspects, RTC allocation 1500 corresponding to the road segment 1503 may be configured, for example, based on an indirect-interference avoidance criterion, for example, a non-direct interference prevention technique, e.g., as described below.

In some demonstrative aspects, as shown in FIG. 15, different lanes of the intersection may be assigned with different sets of RTC settings.

In some demonstrative aspects, vehicles of a same lane of the intersection may be assigned, for example, according to an along-lane allocation rule.

For example, as shown in FIG. 15, the RTC allocation 1500 may be implemented with respect to a five-radar-unit topology. In other aspects, the RTC allocation 1500 may be implemented with any other number of radar radios, e.g., greater than or less than five.

For example, the RTC allocation 1500 may be configured to relate to a US-based driving direction. In other aspects, the RTC allocation 1500 may similarly be expanded to the UK driving direction.

In some demonstrative aspects, as shown in FIG. 15, RTC allocation 1500 may be configured to assign a plurality of different sets of RTC settings to a plurality of lanes of the intersection in the road segment 1503, for example, based on the indirect-interference avoidance criterion.

In some demonstrative aspects, as shown in FIG. 15, RTC allocation 1500 may assume continuation of the lanes post the intersection. For example, a lane 1519 may be assumed to “continue” as the lane 1517 post the intersection.

In some demonstrative aspects, as shown in FIG. 15, RTC allocation 1500 may be configured to assign alternating sets of RTC settings, along a lane, for example, based on the along-lane allocation rule.

In some demonstrative aspects, RTC allocation 1500 may be configured to assign new sets of RTC settings, for example, for each additional input, e.g., lane, which may be added to the intersection.

In one example, a number of RTC settings of RTC allocation 1500 may be greater than, e.g., double the, number of the plurality of RTC settings of RTC allocation 1400 (FIG. 14), for example, for a symmetric case of 4 inputs. For example, a deviation from a structure of RTC allocation 1400 (FIG. 14), or additional inputs RTC allocation 1400 (FIG. 14), may require additional RTC entries.

In some demonstrative aspects, the additional RTC settings may not be required in a static scenario, for example, where vehicles in the junction are static, for example, as side radars in a perpendicular junction input, may be aligned with and/or considered as, front radars of a cross direction of the junction.

In some demonstrative aspects, the additional RTC settings may not be required, for example, in an RTC allocation that is based only on the direct-interference avoidance criterion.

In some demonstrative aspects, the additional RTC settings may be required for example, in a dynamic scenario, where some of the vehicles are static and some are crossing the junction.

In one example, without adding the additional RTC settings, the RTC allocation may be less efficient and many in-direct interferences may be caused by mixed/not-in order alternating subclasses waveforms, which may be created by combinations of moving vehicles and static vehicles.

In some demonstrative aspects, RTC allocation 1500 may be defined based on RTC allocation information, which may be provided, for example, in map information of a map segment corresponding to the road segment 1503.

In some demonstrative aspects, the RTC allocation information may include a plurality of RTC entries corresponding to a plurality of scenarios in the intersection, e.g., as described below.

In some demonstrative aspects, an RTC entry may include scenario information to define the scenario, for example, based on a lane identifier of a lane in the intersection, e.g., as described below.

In some demonstrative aspects, the RTC entry may include scenario information to define the scenario, for example, based on a spatial pose of a radar radio in a vehicle, e.g., as described below.

In some demonstrative aspects, a number of the plurality of scenarios may be based on a number of spatial poses of radar radios, and/or a number of lanes of the intersection, e.g., as described below.

In one example, the RTC allocation information corresponding to the road segment 1503 may include one of more of the following RTC entries:

TABLE 2

| | | Cross | Along |
|---|---|---|---|
| | Lane | Driving | Driving |
| Radar Position | ID | Direction | Direction |
| Front | 1 | Fc1, TS1, | WF_subclass_rule_f |
| | | WF_class_1 | |
| Front | 2 | Fc1, TS2, | WF_subclass_rule_f |
| | | WF_class_1 | |
| Front | 5 & 12 | Fc1, TS3, | WF_subclass_rule_f |
| | | WF_class_1 | |
| Front | 6 & 11 | Fc1, TS4, | WF_subclass_rule_f |
| | | WF_class_1 | |
| Corner_Front_Right | 1 | Fc2, TS1, | WF_subclass_rule_c |
| | | WF_class_1 | |
| Corner_Front_Right | 2 | Fc2, TS2, | WF_subclass_rule_c |
| | | WF_class_1 | |
| Corner_Front_Right | 5 & 12 | Fc2, TS3, | WF_subclass_rule_c |
| | | WF_class_1 | |
| Corner_Front_Right | 6 & 11 | Fc2, TS4, | WF_subclass_rule_c |
| | | WF_class_1 | |

In one example, Table 2 may include RTC entries for a front radar radio of a vehicle, and a front-right-corner radar radio of the vehicle. In other aspects, Table 2 may be expanded to include additional radar locations, e.g., for all radar radios of the vehicle.

In one example, Table 2 may include RTC entries for twelve lanes, denoted 1-12, which may be included in road segment 1503. For example, the lane indices 1-12 may be assigned in a clock-wise manner. For example, the lanes 1 and 2 may have a same driving direction, and lanes 5 and 6 may have a driving direction perpendicular to the driving direction of lanes 1 and 2. In other aspects, Table 2 may be expanded to include more than twelve lanes, for example, for an intersection having more than 12 lanes, e.g., lane inputs.

In some demonstrative aspects, the front-right-corner radar radios in lane 5 and lane 6 may have the same orientation as the front radar radios in the lane 1 and lane 2. Accordingly, the RTC allocation 1500 may be configured to optionally assign a same waveform class to the front-right-corner radar radios in lane 5 and lane 6 and to the front radar radios in the lane 1 and lane 2, for example, with different waveform subclasses, for example, as if these radio units are all along the same lane.

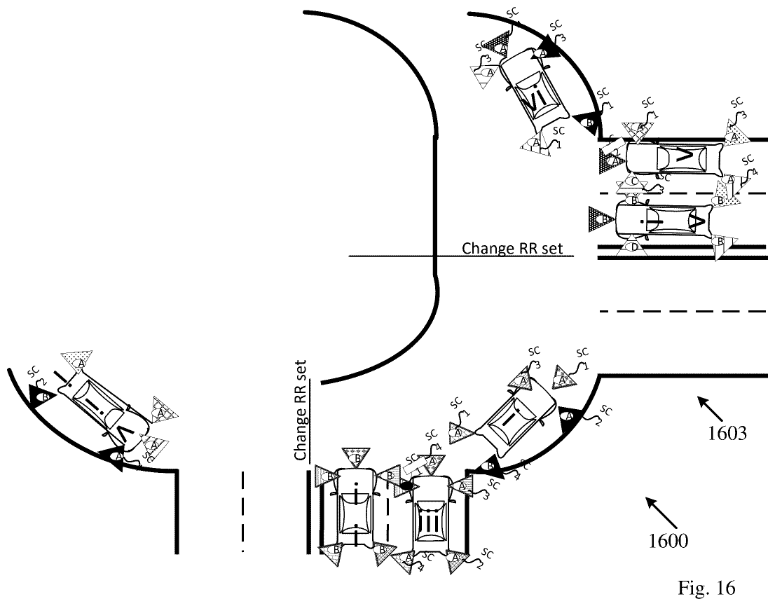

Reference is made to FIG. 16, which schematically illustrates an RTC allocation 1600 corresponding to a road segment 1603, in accordance with some demonstrative aspects.

For example, of the road segment 1603 may include a roundabout.

In some demonstrative aspects, RTC allocation 1600 may be based on a roundabout topology of the roundabout at the road segment 1603.

In some demonstrative aspects, RTC allocation 1600 may be similar to RTC allocation 1500 (FIG. 15).

In some demonstrative aspects, RTC allocation 1600 may be configured to assign a plurality of different sets of RTC settings to a plurality of input lanes to the roundabout, e.g., similar to a static interchange scenario.

In some demonstrative aspects, RTC allocation 1600 may be configured to assign a long-arc set of RTC settings to radar radios in vehicles, which move along a long arc of the roundabout.

In some demonstrative aspects, the RTC allocation 1600 may be configured to assign sets of RTC settings based on RTC allocations for the roundabout inputs, for example, at roundabout inputs, e.g., when entering the roundabout or exiting the roundabout.

In some demonstrative aspects, the RTC allocation 1600 may be configured to maintain RTC settings between roundabout inputs, for example, such that the same RTC setting may be maintained for a vehicle, e.g., as the vehicle moves from a first roundabout input towards a second roundabout input.

For example, the RTC allocation 1600 may be configured to allocate a first RTC setting to a vehicle, e.g., when the vehicle enters a first roundabout input. For example, the RTC allocation 1600 may be configured to maintain the first RTC setting for a vehicle, e.g., when the vehicle moves from the first roundabout input towards a second roundabout input. For example, the RTC allocation 1600 may be configured to allocate a second RTC setting to the vehicle, e.g., when the vehicle reaches the second roundabout input.

In some demonstrative aspects, the RTC allocation 1600 may be configured to assign the long-arc set of RTC settings, for example, for vehicles moving between the roundabout inputs along the long arc of the roundabout.

In some demonstrative aspects, RTC allocation 1600 may be defined based on RTC allocation information, which may be provided, for example, in map information of a map segment corresponding to the road segment 1603 including the roundabout, e.g., as described above.

In some demonstrative aspects, the RTC allocation information may include a plurality of RTC entries corresponding to a plurality of scenarios in the roundabout, e.g., as described above.

Referring back to FIG. 11, in some demonstrative aspects, controller 1120 may be configured to utilize one or more operations and/or functionalities of an RTC assignment mechanism, which may be configured to provide a technical solution to address communication of a set of RTC settings to vehicle 1100, e.g., in a robust manner.

In some demonstrative aspects, the RTC assignment mechanism may utilize an assignment of the set of RTC settings to vehicle 1100 via a wireless communication mechanism, for example, in a real time manner.

In some demonstrative aspects, the set of RTC settings may be provided to vehicle 1100 via the wireless communication mechanism, for example, through the vehicle controller 1150 submitting a route to RTC coordinator 1130, and receiving a set of RTC settings, e.g., per road segment.

In some demonstrative aspects, the RTC assignment mechanism may be configured to support assignment of RTC settings to vehicle 1100 via map information of a map, e.g., as described below.

In some demonstrative aspects, an RTC allocation field may be added to map information of a map. For example, an agreed upon coding may be applied to the map information, for example, to identify the various RTC settings.

In one example, the RTC allocation field may include a plurality of RTC entries to define a plurality of RTC settings, for example, as described above with reference to Table 1 and/or Table 2.

In other aspects, the RTC allocation may be provided according to any other suitable format.

In some demonstrative aspects, a map may be partitioned into road segments. For example, a road segment 1103, e.g., each road segment, may be assigned with its RTC allocation 1113.

In some demonstrative aspects, the map-based assignment may be implemented based on any other additional or alternative segmentation scheme. For example, the RTC allocation 1113 may be assigned per lane of the road segment 1103, for example, to support an indirect-interference avoidance criterion, e.g., as described above.

In some demonstrative aspects, a map owner, or a standard organization, may be in charge of a task to assign the RTC allocation information in the map information of the map, e.g., in a coherent and global way.

In some demonstrative aspects, the RTC assignment mechanism may be configured to assign along-lane RTC settings along a lane, e.g., as described below.

In some demonstrative aspects, the RTC assignment mechanism may be configured to assign an along-lane RTC setting, for example, based on locations of vehicles along the lane (location-based along-lane RTC allocation), e.g., as described below.

In some demonstrative aspects, the location-based along-lane RTC allocation may be based on a relatively accurate positioning of a vehicle along the lane.

In some demonstrative aspects, the location-based along-lane RTC allocation may be predefined, for example, based on partitioning of a lane into a plurality of lane segments.

For example, a length of a lane segment may be configured to include or may be based on, a length of a vehicle and some margin, which may be based, for example, on an average and/or typical driving speed in the lane.

In some demonstrative aspects, the location-based along-lane RTC allocation may be configured based, for example, on an a-priori assumption with respect to the average driving speed and potential interfering radar units, which may be installed on other vehicles and their relative/absolute positions along the lane.

In one example, the location-based along-lane RTC allocation may be configured, for example, according to an along the lane allocation rule, which may be defined, e.g., as follows:
Location_zero=xyz.
Having a set of N members to assign along a lane.
Assume D as the sum of a typical vehicle+twice 2 second (sec) margin. For example, for a 20 meter per second (m/s) typical speed, the 2 sec rule may be equivalent to a margin of about 40m. For example, assuming a typical vehicle length of 4 meter (m), we have D=4+2*40=84m.
Alpha <=1, is an optional margin guard band. In our example we set Alpha to 1.
Hence the rule may be defined as follows:

$$floor ( Alpha * ( Pos\_Next \_Tx \_Frame - Location\_zero ) / D ) mode N$$

Example: Pos_Next_Tx_Frame—Location_zero=1453m, N=4 the member selected is Floor(1*1453/84)(Mod 4)=17.3 (mod 4)=0 for the set [0, 1, 2, 3].

In other aspects, the along the lane allocation rule may be defined based on any other additional or alternative parameters and/or criteria.

In some demonstrative aspects, the location-based along-lane RTC allocation may utilize a large degree of an infrastructure, for example, as the location-based along-lane RTC allocation may require low-latency communication, and communication of real-time information corresponding to positions of other interfering radars and their orientations.

In some demonstrative aspects, the RTC assignment mechanism may be configured to assign the RTC settings along a lane, for example, based on a random allocation of sets of RTC settings to vehicles along the lane (random-based along-lane RTC allocation), e.g., as described below.

In some demonstrative aspects, for example, in some use cases, implementations, and/or scenarios, the random-based along-lane RTC allocation may be implemented to provide a technical solution to support a probability of at least about 30% for an interference free link, e.g., as described below.

In one example, the random-based along-lane RTC allocation may be configured, for example, assuming four RTC settings having a medium or a strong RTC separation strength, and a scenario in which there may be two vehicles in front of an ego vehicle, and two vehicles behind the ego vehicle.

According to this example, a probability of no interference at all may be estimated as 4*0.25*(0.75)\hat{ }⁴=0.31. For example, there may be four RTC settings for the radar radio with a probability of 0.25 for each RTC setting. Therefore, a probability of the ego vehicle to select a particular RTC setting is 0.25. For example, for a case of no interference at all, all the other four vehicles should select one of the three RTC settings other than the particular RTC setting, e.g., with a probability of 0.75 to the power of four.

In one example, the probability to get an interference free link may increase, for example, when the number of possible different RTC settings is more than four. For example, for ten possible RTC settings, the probability of an interference free link may be about 65%, e.g., 10*0.1*0.9\hat{ }⁴=0.65˜⅔>⅓.

According to this example, the ego vehicle may experience an interference-free situation for only one frame out of three. Although this situation may not be optimal, it may provide practical ghost free frames, which may be used as a reference, for example, to avoid and/or mitigate some or all of the ghosts.

In some demonstrative aspects, a temporal filtering may be implemented to remove ghost detections, for example, as a probability of a same vehicle to cause interference in a consecutive frame is 1/N\hat{ }². For example, a probability of a same vehicle to cause the consecutive interference may be 1/16, e.g., for N=4. This probability may be enough for the temporal filtering to reject the ghost detections.

In some demonstrative aspects, the temporal filtering may be capable of removing the ghosts, for example, as different cars may have different random ghost ranges per same object. Accordingly, the detection may jump all over a line of a spatial angle in an angle-range space. This result may be easily rejected by the temporal filtering.

In some demonstrative aspects, the temporal filtering may be capable of removing the ghosts, for example, as a detection along a same line in the angle-range space with a power difference that is not associated with their appearing range difference may also likely to be ghosts.

In some demonstrative aspects, processor 1124 may be configured to implement a temporal filtering method, for example, to remove ghost detections (ghosts), for example, indirect interference ghosts, e.g., as described below.

In some demonstrative aspects, the temporal filtering method may include scrambling an initial pulse phase. For example, a random phase may be subtracted in a receive operation, e.g., before a Doppler calculation phase.

In some demonstrative aspects, the temporal filtering method may include identifying interference free frames in a temporal filtering phase detect anchor. For example, interference free frames may have a below-average detection count and/or a small number of detections with power difference, e.g., compared to interference-affected frames, which may appear on a same line in the Range-Angle space. For example, the interference free frames may be detected based on a model or a data based method.

In some demonstrative aspects, the temporal filtering method may include applying temporal filtering to frames with ghosts, for example, to remove ghost-based detections, which may be probably caused by ghosts.

In some demonstrative aspects, the ghost-based detections may be detected by identifying detections with a power difference, which may appear on a same line in the range-angle space.

In some demonstrative aspects, the ghost-based detections may be detected by identifying detections, which may not be consistent in their range property, e.g., along consecutive frames.

In some demonstrative aspects, the ghost-based detections may be detected by identifying detections, which may not be consistent in their Doppler property, e.g., along consecutive frames.

In one example, a random along-lane RTC allocation method may be utilized, for example, for front radars installed on vehicles driving along the same lane.

In one example, the random along-lane RTC allocation method may be implemented, for example, according to one or more, e.g., some or all, of the following operations:
Assign a set including four RTC settings, or more, to the front radars installed on vehicles driving along the same lane.
For each front radar, select, e.g., randomly (uniform distribution) select, an RTC setting, e.g., every new Tx frame.
In the Temporal processing layer:
   Identify a frame without interference as an anchor. For example, about ⅓ or more of the frames are expected to be without interference, e.g., from two vehicles in the front and two in the rear, e.g., as described above.
   Use the Temporal Filtering Method to remove the ghost-based detections, e.g., the indirect interference ghosts.
   It may be expected that per object, e.g., in less than 1% of the frames, the object may be covered by a removed ghost detection.

In other aspects, any other method may be defined for front radar radios installed on vehicles driving along the same lane.

In one example, a random similar-orientation-RTC allocation method may be utilized, for example, for corner radar radios having similar orientation, which may be installed on vehicles driving along different lanes or in a junction with many inputs.

In one example, the random similar-orientation-RTC allocation method may be implemented, for example, according to one or more, e.g., some or all, of the following operations:
Assign a set including four RTC settings, or more, for example, to the corner radars with similar orientations installed on vehicles driving along different lanes.
For each corner radar, select, e.g., randomly (uniform distribution) select, an RTC setting, e.g., every new Tx frame.
In the Temporal processing layer:
   Identify a frame without interference as an anchor. For example, about ⅓ or more of the frames are expected to be without interference, e.g., from two vehicles in the front and two in the rear, e.g., as described above.
   Use the Temporal Filtering Method to remove the ghost-based detections, e.g., the indirect interference ghosts.
   It may be expected that per object, e.g., in less than 1% of the frames, the object may be covered by a removed ghost detection.

In other aspects, any other suitable operations and/or method may be defined.

In some demonstrative aspects, the RTC assignment mechanism may be configured to support timing synchronization, for example, between vehicles, for example, in case a time slot is one of the RTC parameters of an RTC setting.

In some demonstrative aspects, the timing synchronization may be achieved, for example, through a GPS time base, for example, with some rule regarding a zero time boundary. For example, the time boundary may be set to a second boundary or a minute boundary in an off-line agreed upon manner, per information from a server, and/or per an indication in the map field, e.g., using a time sync rule field.

In one example, the timing synchronization may be in a range of microseconds or milliseconds.

In some demonstrative aspects, an RTC allocation and assignment mechanism may be configured to support fault recovery, e.g., as described below.

For example, the RTC allocation and assignment mechanism may be expected to avoid and/or mitigate most of interference from legacy radar units, although some radar units may have the capacity to assign radio transmit configurations partially or fully.

For example, in case of a vehicle on the road that does not act according to the rules, and interference from this vehicle may not be properly avoided, vehicle 1100 may move to a reserved RTC set, or to one of a plurality of reserved RTC sets.

For example, processor 1124 may allocate a reserved RTC set to radar radios 1110, for example, based on the map.

For example, RTC coordinator 1130 may allocate one or more reserved RTC sets to vehicle 1100, for example, by real time communication.

For example, processor 1124 may release the reserved RTC set, for example, based on a determination that the interference from the interfering vehicle is resolved.

In some demonstrative aspects, processor 1124 may be configured to support hopping between the assigned RTC set and the reserved RTC sets, for example, if the reserved RTC sets are not “clean” of interference.

In some demonstrative aspects, processor 1124 may be configured to utilized a pre-programmed rule, for example, in case that no instruction for hopping, or in case a specific RTC setting is not defined to avoid or mitigate the interference from the interfering vehicle.

In some demonstrative aspects, processor 1124 may be configured to randomly select an RTC setting, for example, from an entire available set of RTC settings.

For example, processor 1124 may determine the following parameters for an RTC setting, for example, according to Table 1, e.g., as follows:

$$Fci , i = 1 , … , 4$$

$$TSj , j = 1 , … , 5$$

$$Waveform\_Class \_k , K = 1 , … , 4$$

$$Waveform\_subclass \_rule \_f .$$

In some demonstrative aspects, the RTC allocation and assignment mechanism may be configured to support real time monitoring and/or reporting of the interference level per radar unit, for example, to improve the RTC allocations.

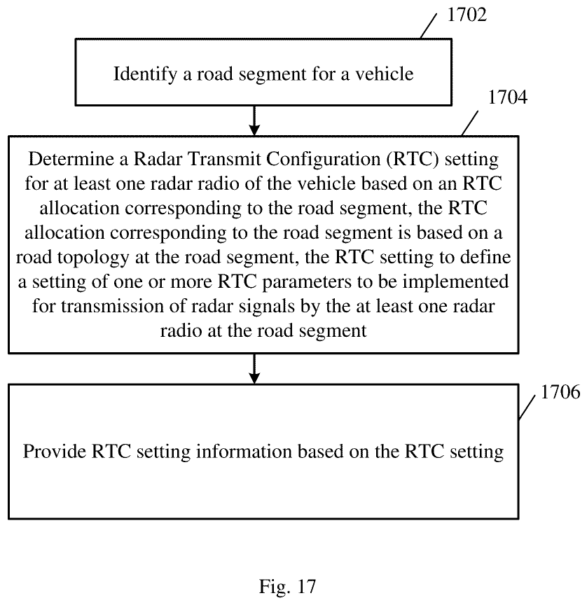

Reference is made to FIG. 17, which schematically illustrates a method of determining an RTC setting for at least one radar radio of a vehicle, in accordance with some demonstrative aspects. For example, one or more of the operations of the method of FIG. 17 may be performed by a system, e.g., radar system 900 (FIG. 9), and/or system 1101 (FIG. 11), a radar device, e.g., radar device 101 (FIG. 1), radar device 800 (FIG. 8), and/or radar device 910 (FIG. 9); a controller, e.g., controller 1120 (FIG. 11), and/or a processor, e.g., processor 1124 (FIG. 11).

As indicated at block 1702, the method may include identifying a road segment for a vehicle. For example, processor 1124 (FIG. 11) may be configured to identify the road segment 1103 (FIG. 11) for the vehicle 1100 (FIG. 11), e.g., as described above.

As indicated at block 1704, the method may include determining an RTC setting for at least one radar radio of the vehicle based on an RTC allocation corresponding to the road segment. For example, the RTC allocation corresponding to the road segment may be based on a road topology at the road segment. For example, the RTC setting may define a setting of one or more RTC parameters to be implemented for transmission of radar signals by the at least one radar radio at the road segment. For example, processor 1124 (FIG. 11) may be configured to determine the RTC setting 1125 (FIG. 11) for the at least one radar radio 1110 (FIG. 11) of the vehicle 1100 (FIG. 11), for example, based on the RTC allocation 1113 (FIG. 11) corresponding to the road segment 1103 (FIG. 11), e.g., as described above.

As indicated at block 1706, the method may include providing RTC setting information based on the RTC setting. For example, processor 1124 (FIG. 11) may be configured to provide, e.g., via output 1126 (FIG. 11), the RTC setting information 1128 (FIG. 11) based on the RTC setting 1125 (FIG. 11), e.g., as described above.

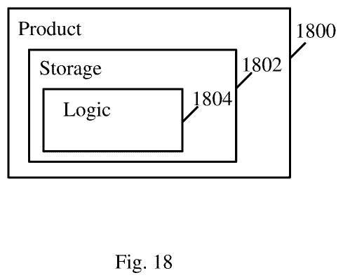

Reference is made to FIG. 18, which schematically illustrates a product of manufacture 1800, in accordance with some demonstrative aspects. Product 1800 may include one or more tangible computer-readable (“machine-readable”) non-transitory storage media 1802, which may include computer-executable instructions, e.g., implemented by logic 1804, operable to, when executed by at least one computer processor, enable the at least one computer processor to implement one or more operations and/or functionalities described with reference to any of the FIGS. 1-17, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1800 and/or machine-readable storage media 1802 may include one or more types of computer-readable storage media capable of storing data, including volatile memory, non-volatile memory, removable or non-removable memory, erasable or non-erasable memory, writeable or re-writeable memory, and the like. For example, machine-readable storage media 1802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to identify a road segment for a vehicle; and determine a Radar Transmit Configuration (RTC) setting for at least one radar radio of the vehicle based on an RTC allocation corresponding to the road segment, the RTC allocation corresponding to the road segment is based on a road topology at the road segment, the RTC setting to define a setting of one or more RTC parameters to be implemented for transmission of radar signals by the at least one radar radio at the road segment; and an output to provide RTC setting information based on the RTC setting.

Example 2 includes the subject matter of Example 1, and optionally, wherein the RTC allocation corresponding to the road segment is configured based on a direct-interference avoidance criterion configured to avoid direct interference caused by radar signals transmitted from a first radar radio of a first vehicle in the road segment and received directly by a second radar radio of a second vehicle in the road segment.

Example 3 includes the subject matter of Example 2, and optionally, wherein the direct-interference avoidance criterion is configured to selectively allow or prohibit assignment of a same RTC setting to the first radar radio and the second radar radio based on a Line of Sight (LoS) rule requiring that a LoS between the first radar radio and the second radar radio according to the road topology does not pass through both a first Field of View (FoV) of the first radar radio and a second FoV of the second radar radio.

Example 4 includes the subject matter of Example 2 or 3, and optionally, wherein the direct-interference avoidance criterion is configured to allow assignment of a same RTC setting to the first radar radio and the second radar radio according to a boresight rule requiring that a first boresight of the first radar radio according to the road topology is within a predefined margin from a second boresight of the second radar radio according to the road topology.

Example 5 includes the subject matter of any one of Examples 1-4, and optionally, wherein the RTC allocation corresponding to the road segment is configured to prohibit allocation of a same RTC setting to a first vehicle in a first lane segment of a first lane having a first driving direction and to a second vehicle in a second lane segment of a second lane having a second driving direction if a Line of Sight (LoS) between the first lane segment and the second lane segment is clear according to the road topology, and to allow allocation of the same RTC setting to the first vehicle and the second vehicle if the LoS between the first lane segment and the second lane segment is blocked according to the road topology.

Example 6 includes the subject matter of any one of Examples 1-5, and optionally, wherein the RTC allocation corresponding to the road segment is configured based on an indirect-interference avoidance criterion configured to avoid indirect interference caused by radar signals transmitted from a first radar radio of a first vehicle in the road segment and received, via reflection from one or more objects, by a second radar radio of a second vehicle in the road segment.

Example 7 includes the subject matter of Example 6, and optionally, wherein the indirect-interference avoidance criterion is configured to prohibit assignment of a same RTC setting to the first radar radio and the second radar radio if a first boresight of the first radar radio according to the road topology is within a predefined margin from a second boresight of the second radar radio according to the road topology.

Example 8 includes the subject matter of any one of Examples 1-7, and optionally, wherein the RTC allocation corresponding to the road segment is configured to allow or prohibit assignment of a same RTC setting to the first radar radio and the second radar radio according to a Line of Sight (LoS) rule configured to identify whether or not a LoS between the first radar radio and the second radar radio according to the road topology passes through both a first Field of View (FoV) of the first radar radio and a second FoV of the second radar radio.

Example 9 includes the subject matter of any one of Examples 1-8, and optionally, wherein the RTC allocation corresponding to the road segment is configured to allow or prohibit assignment of a same RTC setting to the first radar radio and the second radar radio according to a boresight rule configured to identify whether or not a first boresight of the first radar radio according to the road topology is within a predefined margin from a second boresight of the second radar radio according to the road topology.

Example 10 includes the subject matter of Example 9, and optionally, wherein the predefined margin is based on the road topology at the road segment.

Example 11 includes the subject matter of any one of Examples 1-10, and optionally, wherein the RTC allocation corresponding to the road segment is configured to assign a plurality of sets of RTC settings to a plurality of lanes in the road segment, the plurality of sets of RTC settings comprising a first set of RTC settings for vehicles in a first lane, and a second set of RTC settings for vehicles in a second lane, the first set of RTC settings different from the second set of RTC settings.

Example 12 includes the subject matter of Example 11, and optionally, wherein the processor is configured to select a particular set of RTC settings from the plurality of sets of RTC settings based on a particular lane for the vehicle, and to determine the RTC setting for the at least one radar radio of the vehicle comprising at least one particular RTC setting in the particular set of RTC settings.

Example 13 includes the subject matter of Example 11 or 12, and optionally, wherein the first set of RTC settings comprises a plurality of first RTC settings corresponding to a plurality of radar radio spatial poses for the vehicles in the first lane, wherein the second set of RTC settings comprises a plurality of second RTC settings corresponding to the plurality of radar radio spatial poses for the vehicles in the second lane.

Example 14 includes the subject matter of any one of Examples 1-13, and optionally, wherein the RTC setting comprises an along-lane setting configured to define a setting of at least one RTC parameter of the one or more RTC parameters based on a location of the vehicle along a lane.

Example 15 includes the subject matter of Example 14, and optionally, wherein the RTC allocation corresponding to the road segment is configured to define a plurality of predefined along-lane settings for the at least one RTC parameter, the processor configured to randomly select a particular along-lane setting from the plurality of predefined along-lane settings, and to configure the RTC setting comprising the particular along-lane setting for the at least one RTC parameter.

Example 16 includes the subject matter of Example 15, and optionally, wherein the processor is configured to adjust the setting of the at least one RTC parameter based on the location of the vehicle along the particular lane.

Example 17 includes the subject matter of Example 15 or 16, and optionally, wherein the RTC allocation corresponding to the road segment is configured to reuse the plurality of predefined along-lane settings with respect to a plurality of lane portions along the lane.

Example 18 includes the subject matter of Example 17, and optionally, wherein a length of a lane portion of the plurality of lane portions is based on a count of predefined along-lane settings in the plurality of predefined along-lane settings.

Example 19 includes the subject matter of any one of Examples 1-18, and optionally, wherein the processor is configured to identify RTC allocation information in map information of a map segment corresponding to the road segment, the RTC allocation information to define the RTC allocation corresponding to the road segment.

Example 20 includes the subject matter of Example 19, and optionally, wherein the RTC allocation information comprises a plurality of RTC entries corresponding to a plurality of scenarios, wherein an RTC entry corresponding to a scenario comprises scenario-based RTC information to define a scenario-based setting of the one or more RTC parameters for the scenario.

Example 21 includes the subject matter of Example 20, and optionally, wherein the plurality of RTC entries comprises a first RTC entry corresponding to a first scenario and a second RTC entry corresponding to a second scenario, wherein the first RTC entry comprises first scenario-based RTC information to define a first setting of the one or more RTC parameters for the first scenario, the second RTC entry comprises second scenario-based RTC information to define a second setting, different from the first setting, of the one or more RTC parameters for the second scenario.

Example 22 includes the subject matter of Example 21, and optionally, wherein the RTC entry comprises scenario information to define the scenario based on a lane identifier.

Example 23 includes the subject matter of Example 21 or 22, and optionally, wherein the RTC entry comprises scenario information to define the scenario based on a radar radio spatial pose.

Example 24 includes the subject matter of any one of Examples 20-23, and optionally, wherein the scenario-based RTC information comprises along-lane setting information to define a setting of at least one RTC parameter of the one or more RTC parameters for the scenario based on a location of the vehicle along a lane.

Example 25 includes the subject matter of any one of Examples 1-24, and optionally, wherein the processor is configured to determine the RTC setting to define the setting of the one or more RTC parameters based on a spatial pose of the at least one radar radio of the vehicle.

Example 26 includes the subject matter of any one of Examples 1-25, and optionally, wherein the processor is configured to determine the RTC setting to define a first setting of the one or more RTC parameters for a first radar radio at a first spatial pose, and to define a second setting of the one or more RTC parameters for a second radar radio at a second spatial pose, the second setting of the one or more RTC parameters different from the first setting of the one or more RTC parameters.

Example 27 includes the subject matter of any one of Examples 1-26, and optionally, wherein the RTC allocation is based on a lane configuration of one or more lanes at the road segment.

Example 28 includes the subject matter of Example 27, and optionally, wherein the lane configuration comprises at least one of a count of the one or more lanes, or a driving-direction of the one or more lanes.

Example 29 includes the subject matter of any one of Examples 1-28, and optionally, wherein the RTC allocation is based on one or more road traces at the road segment.

Example 30 includes the subject matter of any one of Examples 1-29, and optionally, wherein the RTC allocation is based on at least one of a junction topology at the road segment, an interchange topology at the road segment, a roundabout topology at the road segment, or a ramp topology at the at the road segment.

Example 31 includes the subject matter of any one of Examples 1-30, and optionally, wherein the RTC allocation is based on a land cover at the road segment.

Example 32 includes the subject matter of any one of Examples 1-31, and optionally, wherein the one or more RTC parameters comprises at least one of a frequency range, a time slot, a waveform, a polarization, a coding, or a frame structure.

Example 33 includes the subject matter of any one of Examples 1-32, and optionally, comprising an in-vehicle RTC controller configured for implementation in the vehicle, the in-vehicle RTC controller comprising the processor, and the output configured to provide the RTC setting information to the at least one radar radio.

Example 34 includes the subject matter of Example 33, and optionally, wherein the processor is configured to determine the RTC allocation corresponding to the road segment based on RTC allocation information received by the vehicle.

Example 35 includes the subject matter of Example 33 or 34, and optionally, comprising a radar system, the radar system comprising the at least one radar radio, and a radar processor configured to generate radar information based on the radar signals.

Example 36 includes the subject matter of Example 35, and optionally, comprising a vehicle, the vehicle comprising the radar system, and a system controller to control one or more systems of the vehicle based on the radar information.

Example 37 includes the subject matter of any one of Examples 1-32, and optionally, comprising an RTC coordinator to coordinate RTC settings for vehicles in a plurality of road segments, the RTC coordinator comprising the processor, and a communication interface to transmit the RTC setting information to the vehicle.

Example 38 includes the subject matter of Example 37, and optionally, wherein the processor is configured to process location information received from the vehicle to determine the road segment for the vehicle, and to configure the RTC setting information for the vehicle based on the RTC allocation corresponding to the road segment for the vehicle.

Example 39 includes a product comprising one or more tangible computer-readable non-transitory storage media comprising instructions operable to, when executed by at least one processor, enable the at least one processor to cause a Radar

Transmit Configuration (RTC) controller to perform any of the described operations of any of Examples 1-38.

Example 40 includes a Radar Transmit Configuration (RTC) controller comprising the subject matter of any of Examples 1-38.

Example 41 includes a radar device comprising the subject matter of any of Examples 1-38.

Example 42 includes a vehicle comprising the subject matter of any of Examples 1-38.

Example 43 includes an apparatus comprising means for performing any of the described operations of any of Examples 1-38.

Example 44 includes a machine-readable medium that stores instructions for execution by a processor to perform any of the described operations of any of Examples 1-38.

Example 45 comprises a product comprising one or more tangible computer-readable non-transitory storage media comprising instructions operable to, when executed by at least one processor, enable the at least one processor to cause a device and/or system to perform any of the described operations of any of Examples 1-38.

Example 46 includes an apparatus comprising a memory; and processing circuitry configured to perform any of the described operations of any of Examples 1-38.

Example 47 includes a method including any of the described operations of any of Examples 1-38.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to:
identify a road segment for a vehicle; and
determine a Radar Transmit Configuration (RTC) setting for at least one radar radio of the vehicle based on an RTC allocation corresponding to the road segment, the RTC allocation corresponding to the road segment is based on a road topology at the road segment, the RTC setting to define a setting of one or more RTC parameters to be implemented for transmission of radar signals by the at least one radar radio at the road segment; and
an output to provide RTC setting information based on the RTC setting.

2. The apparatus of claim 1, wherein the RTC allocation corresponding to the road segment is configured based on a direct-interference avoidance criterion configured to avoid direct interference caused by radar signals transmitted from a first radar radio of a first vehicle in the road segment and received directly by a second radar radio of a second vehicle in the road segment.

3. The apparatus of claim 2, wherein the direct-interference avoidance criterion is configured to selectively allow or prohibit assignment of a same RTC setting to the first radar radio and the second radar radio based on a Line of Sight (LoS) rule requiring that a LoS between the first radar radio and the second radar radio according to the road topology does not pass through both a first Field of View (FoV) of the first radar radio and a second FoV of the second radar radio.

4. The apparatus of claim 2, wherein the direct-interference avoidance criterion is configured to allow assignment of a same RTC setting to the first radar radio and the second radar radio according to a boresight rule requiring that a first boresight of the first radar radio according to the road topology is within a predefined margin from a second boresight of the second radar radio according to the road topology.

5. The apparatus of claim 1, wherein the RTC allocation corresponding to the road segment is configured to prohibit allocation of a same RTC setting to a first vehicle in a first lane segment of a first lane having a first driving direction and to a second vehicle in a second lane segment of a second lane having a second driving direction if a Line of Sight (LoS) between the first lane segment and the second lane segment is clear according to the road topology, and to allow allocation of the same RTC setting to the first vehicle and the second vehicle if the LoS between the first lane segment and the second lane segment is blocked according to the road topology.

6. The apparatus of claim 1, wherein the RTC allocation corresponding to the road segment is configured based on an indirect-interference avoidance criterion configured to avoid indirect interference caused by radar signals transmitted from a first radar radio of a first vehicle in the road segment and received, via reflection from one or more objects, by a second radar radio of a second vehicle in the road segment.

7. The apparatus of claim 6, wherein the indirect-interference avoidance criterion is configured to prohibit assignment of a same RTC setting to the first radar radio and the second radar radio if a first boresight of the first radar radio according to the road topology is within a predefined margin from a second boresight of the second radar radio according to the road topology.

8. The apparatus of claim 1, wherein the RTC allocation corresponding to the road segment is configured to allow or prohibit assignment of a same RTC setting to the first radar radio and the second radar radio according to a Line of Sight (LoS) rule configured to identify whether or not a LoS between the first radar radio and the second radar radio according to the road topology passes through both a first Field of View (FoV) of the first radar radio and a second FoV of the second radar radio.

9. The apparatus of claim 1, wherein the RTC allocation corresponding to the road segment is configured to allow or prohibit assignment of a same RTC setting to the first radar radio and the second radar radio according to a boresight rule configured to identify whether or not a first boresight of the first radar radio according to the road topology is within a predefined margin from a second boresight of the second radar radio according to the road topology.

10. The apparatus of claim 1, wherein the RTC allocation corresponding to the road segment is configured to assign a plurality of sets of RTC settings to a plurality of lanes in the road segment, the plurality of sets of RTC settings comprising a first set of RTC settings for vehicles in a first lane, and a second set of RTC settings for vehicles in a second lane, the first set of RTC settings different from the second set of RTC settings.

11. The apparatus of claim 10, wherein the first set of RTC settings comprises a plurality of first RTC settings corresponding to a plurality of radar radio spatial poses for the vehicles in the first lane, wherein the second set of RTC settings comprises a plurality of second RTC settings corresponding to the plurality of radar radio spatial poses for the vehicles in the second lane.

12. The apparatus of claim 1, wherein the RTC setting comprises an along-lane setting configured to define a setting of at least one RTC parameter of the one or more RTC parameters based on a location of the vehicle along a lane.

13. The apparatus of claim 12, wherein the RTC allocation corresponding to the road segment is configured to define a plurality of predefined along-lane settings for the at least one RTC parameter, the processor configured to randomly select a particular along-lane setting from the plurality of predefined along-lane settings, and to configure the RTC setting comprising the particular along-lane setting for the at least one RTC parameter.

14. The apparatus of claim 13, wherein the RTC allocation corresponding to the road segment is configured to reuse the plurality of predefined along-lane settings with respect to a plurality of lane portions along the lane, wherein a length of a lane portion of the plurality of lane portions is based on a count of predefined along-lane settings in the plurality of predefined along-lane settings.

15. The apparatus of claim 1, wherein the processor is configured to identify RTC allocation information in map information of a map segment corresponding to the road segment, the RTC allocation information to define the RTC allocation corresponding to the road segment.

16. The apparatus of claim 15, wherein the RTC allocation information comprises a plurality of RTC entries corresponding to a plurality of scenarios, wherein an RTC entry corresponding to a scenario comprises scenario-based RTC information to define a scenario-based setting of the one or more RTC parameters for the scenario.

17. The apparatus of claim 16, wherein the RTC entry comprises scenario information to define the scenario based on at least one of a lane identifier, or a radar radio spatial pose.

18. The apparatus of claim 16, wherein the scenario-based RTC information comprises along-lane setting information to define a setting of at least one RTC parameter of the one or more RTC parameters for the scenario based on a location of the vehicle along a lane.

19. The apparatus of claim 1, wherein the processor is configured to determine the RTC setting to define the setting of the one or more RTC parameters based on a spatial pose of the at least one radar radio of the vehicle.

20. The apparatus of claim 1, wherein the RTC allocation is based on at least one of a lane configuration of one or more lanes at the road segment, one or more road traces at the road segment, a junction topology at the road segment, an interchange topology at the road segment, a roundabout topology at the road segment, a ramp topology at the at the road segment, or a land cover at the road segment.

21. The apparatus of claim 1, wherein the one or more RTC parameters comprises at least one of a frequency range, a time slot, a waveform, a polarization, a coding, or a frame structure.

22. The apparatus of claim 1 comprising an in-vehicle RTC controller configured for implementation in the vehicle, the in-vehicle RTC controller comprising the processor, and the output configured to provide the RTC setting information to the at least one radar radio.

23. The apparatus of claim 1 comprising an RTC coordinator to coordinate RTC settings for vehicles in a plurality of road segments, the RTC coordinator comprising the processor, and a communication interface to transmit the RTC setting information to the vehicle.

24. The apparatus of claim 23, wherein the processor is configured to process location information received from the vehicle to determine the road segment for the vehicle, and to configure the RTC setting information for the vehicle based on the RTC allocation corresponding to the road segment for the vehicle.

25. A product comprising one or more tangible computer-readable non-transitory storage media comprising instructions operable to, when executed by at least one processor, enable the at least one processor to:
identify a road segment for a vehicle;
determine a Radar Transmit Configuration (RTC) setting for at least one radar radio of the vehicle based on an RTC allocation corresponding to the road segment, the RTC allocation corresponding to the road segment is based on a road topology at the road segment, the RTC setting to define a setting of one or more RTC parameters to be implemented for transmission of radar signals by the at least one radar radio at the road segment; and
provide RTC setting information based on the RTC setting.

26. The product of claim 25, wherein the RTC allocation corresponding to the road segment is configured to allow or prohibit assignment of a same RTC setting to the first radar radio and the second radar radio according to a Line of Sight (LoS) rule configured to identify whether or not a LoS between the first radar radio and the second radar radio according to the road topology passes through both a first Field of View (FoV) of the first radar radio and a second FoV of the second radar radio.
